(19) United States
(12) Patent Application Publication
(10) Pub. No.: US 2012/0251993 A1
(43) Pub. Date: Oct. 4, 2012

(54) METHOD AND SYSTEM FOR PROMOTING HEALTH EDUCATION

(75) Inventors: Puthugramam K. CHIDAMBARAN, Potomac, MD (US); Preeta Chidambaran, Potomac, MD (US)

(73) Assignee: iHealthEngines, Potomac, MD (US)

(21) Appl. No.: 13/429,115

(22) Filed: Mar. 23, 2012

Related U.S. Application Data
(60) Provisional application No. 61/516,099, filed on Mar. 28, 2011.
(60) Provisional application No. 61/594,808, filed on Feb. 3, 2012.

(51) Int. Cl. G09B 7/00

(52) U.S. Cl. 434/362

(57) ABSTRACT

Provided herein is a method and system for promoting health education. The system can comprise an integrated health education and support platform, such as personalized health education and information. The personalized health education system can comprise a custom tailored education video delivered to a subject conveniently; a self reminder system, such as a customized and personalized health maintenance reminder; a reward and patient medical education credit system, or any combination thereof.

### CROSS REFERENCE

This application claims the benefit of U.S. Provisional Application 61/516,099, filed on Mar. 28, 2011, and U.S. Provisional Application 61/594,808, filed on Feb. 3, 2012, each of which is incorporated by reference herein in its entirety.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND

Rising healthcare costs and complex disease management have forced subjects to take on more responsibility and risks of managing their health. Today, subjects are more involved in navigating the healthcare system than in making the timely interventions necessary to manage their medical conditions and health. Although an increasing number of healthcare providers have initiated health management programs for subjects in recent years, the success of these programs is limited by subjects' motivation and initiative to engage and remain engaged in their overall health. The challenge lies in communicating the educational content in such a way that the subject will be and remain motivated and engaged in their overall health.

### BRIEF DESCRIPTION OF THE DRAWINGS

FIG. 1 depicts a computer system for personalized health education.

FIG. 2 depicts an illustrative input module display for a subject to view and interact.

FIG. 3 depicts a model for how a personalized, subject-based health education system can improve general healthcare.

FIG. 4 depicts an illustrative input module display interface depicting how a component therein can be displayed or hidden.

FIG. 5 depicts an illustrative video content display wherein slides are populated with a listing of points as the video plays.

FIG. 6 depicts an illustrative means to play and stop educational videos and depiction of progress bar display.

FIG. 7 depicts an illustrative progress bar depiction for a subject's access to educational content.

FIG. 8 depicts an illustrative Table of Contents (TOC) display.

FIG. 9 depicts an illustrative means by which a user can access educational content through the TOC while viewing a quiz or test.

FIG. 10 depicts an illustrative means of how a user can access educational content through the TOC.

FIG. 11 depicts an illustrative quiz/test display to a subject.

FIG. 12 depicts an illustrative quiz results display.

FIG. 13 depicts an illustrative educational content display for review of results from a quiz or test.

FIG. 14 depicts an example of an information link available to a subject while viewing educational content.

FIG. 15 depicts a block diagram illustrating a first example architecture of a computer system that can be used in connection with example embodiments of the present invention.

FIG. 16 depicts a diagram illustrating a computer network that can be used in connection with example embodiments of the present invention.

FIG. 17 depicts a block diagram illustrating a second example architecture of a computer system that can be used in connection with example embodiments of the present invention.

FIG. 18 depicts flow of information among a patient, a doctor, and a text interface.

### SUMMARY OF THE INVENTION

In some embodiments, the invention provides a personalized video education system comprising: a) a plurality of segments each comprising an educational video and a quiz, wherein each quiz contains questions associated with the educational video; b) a user-input module configured to receive personal information of a subject; c) a customized script for concatenation of two or more of the segments to generate personalized video education content based on the personal information of the subject; and d) a delivery module operable to deliver the personalized video education content to the subject, wherein the personalized video education system runs on a computer.

In some embodiments, the invention provides a method for encouraging participation in an education program, the method comprising using a computer for: a) collecting one or more parameters for a subject; b) storing the collected parameters electronically; c) generating a customized educational curriculum for the subject based on the collected parameters, wherein the customized educational curriculum comprises a plurality of segments each comprising an educational video and a quiz, wherein each quiz contains questions associated with the educational video, wherein a customized script for concatenation of two or more of the segments is used to generate the customized educational curriculum based on the collected parameters; d) electronically monitoring and storing progress of the subject through the customized educational curriculum; and e) providing rewards to the subject according to progress through the customized educational curriculum.

In some embodiments, the invention provides a computer system for promoting personalized health education, the system comprising: a) a user-input module operable to input personal health information of a subject; b) an educational module comprising a queue of segments, wherein at least one of the segments comprises an educational video and a quiz, wherein each quiz contains questions associated with the educational video, wherein the educational module is operable to provide personalized health education for the subject based on the subject's personal health information; c) a reminder module operable to provide a personalized reminder to the subject to: i) access personalized health educational content from the educational module; or ii) perform a health-related activity; and d) a rewards module operable to provide a credit for the subject's accessing of the personalized health educational content.

In some embodiments, the invention provides a method for promoting personalized health education, the method comprising using a computer for: a) analyzing health information of a subject; b) providing personalized health education for the subject based on the subject's health information, wherein the personalized health education comprises at least one educational video and a quiz, wherein each quiz contains questions associated with the educational video; c) providing a personalized reminder to the subject to: i) access personalized health educational content from the educational module; or ii) perform a health-related activity; and d) providing a credit for the subject's accessing of the personalized health educational content, wherein the credit can be redeemed for a reward.

### DETAILED DESCRIPTION OF THE INVENTION

The present invention focuses on the needs and preferences of a subject, rather than on those of a health care provider. Systems focused on the interests of the health care provider are ordinarily driven by medical encounters, such as when a subject visits a physician or has a prescription fulfilled, and by disclosure of health information of a subject by a health care system or the subject. Systems focused on the provider do not typically address primary prevention of conditions undetected by the health care system, for example, a condition in a high-risk subject who has not recently had a medical encounter. Examples of such risks include undiagnosed: Diabetes Mellitus (DM), hypertension (HTN), obesity, metabolic syndrome, pre-diabetes, and pre-hypertension. Furthermore, the provider-based system often fails to work effectively for subjects with chronic disease due to the multiple visits with specialists necessitated by the chronic disease, and the resulting uncoordinated records and instructions from the providers. In addition, providers tend to provide instructions by ineffective means, for example, in the form of mail letters, rather than using a more efficient and convenient electronic method, for example, email, MMS, or webpage. Provider instructions also do not educate subjects about health maintenance details. Finally, the responsibility to initiate contact with the subject and to input data to initiate health care activities often lies with the primary care provider and the health care system in provider-based systems.

The systems and methods of the present invention overcome these problems by empowering the subject to learn, explore, and discover health care information at the subject's convenience, rather than at the convenience of the health care provider. Using the systems and methods disclosed herein, the subject can investigate any aspect of health, for example, the subject's personal health needs, or generalities regarding well-being, prevention, or medical curiosity. Rather than be limited by the educational and instructional offerings of the health care provider, the subject can learn about whatever topic is of interest to the subject, improve the subject's own health, and find answers to questions when the subject needs information instead of waiting for information from a provider. The efficacy of the invention is improved by the convenience, accessibility, and enjoyment of use.

Provided herein is a system of health education and a method of providing and using the system. The present invention relates to a personalized video education system and method for encouraging participation in an education program that can use personalized health maintenance reminders as part of an integrated health education and support platform that allows individuals to increase their engagement and compliance in their health care and disease management. In one embodiment, the system comprises a plurality of segments each comprising an educational video and a quiz, a user-input module configured to receive personal information of a subject, a customized script for concatenation of two or more segments to generate personalized video education content based on the personal information of a subject, and a delivery module operable to deliver personalized video education content to a subject. Each educational video can be a health education video, and the videos can have multilingual support, or support for the hearing impaired. The user input module can receive personal information of a subject from a clinician, a subject's electronic medical records (EMRs), a subject's pharmacy medical records (PMRs), or a combination thereof.

The disclosed system can further comprise a rewards module configured to deliver a reward to the subject. The reward can be based on an effort by the subject, an outcome achieved by the subject, or both. In some embodiments, the reward is based on the effort of the subject. The reward can be personalized based on the health information of the subject and the credit can be provided based on the frequency of a subject's effort or accessing of personalized health educational content. Non-limiting examples of the effort of the subject include viewing personalized video education content, providing data to the user-input module, reading an article, answering one or more questions each based on the personalized video education content, and providing integration of the user-input module with EMRs or PMRs. Non-limiting examples of a reward include points towards completion of a certificate, points redeemable for services from a redemption network, cash, health and wellness products, discounts within a redemption network, and improved status, such as premier status. The reward can be redeemed using one or more effective means of delivery, such as email, text messages, mail, or telephone.

In one embodiment, the information can be provided to a clinician regarding one or more rewards awarded to the subject.

Another aspect of the present invention relates to a method for encouraging participation in a health education program. The method comprises collecting one or more parameters for a subject, storing the collected parameters electronically, generating a customized curriculum for the subject based on the collected parameters, electronically monitoring and storing progress of a subject through a customized curriculum, and providing rewards to a subject according to progress through a customized curriculum. Each parameter can comprise health information of a subject.

The method can comprise providing a disincentive to a subject according to lack of progress through the customized curriculum. Non-limiting examples of a disincentive include loss of rewards, for example, loss of premier status.

Another aspect of the present invention relates to a computer system for promoting personalized health education. The computer system can comprise a user-input module operable to input personal health information of a subject, an educational module operable to provide personalized health education for a subject based on a subject's personal health information, a reminder module operable to provide a personalized reminder to a subject to access personalized health educational content from an educational module or perform a health-related activity, and a rewards module operable to provide a credit for a subject's accessing of personalized health educational content.

The reminder module can comprise a queue of segments. Each segment can comprise at least one educational video and at least one question associated with the educational video. The reminder module can be triggered as a result of input, such as clinician input or user input.

Another aspect of the disclosed invention relates to a method for promoting personalized health education. The method can comprise analyzing health information of a subject, providing personalized health education for a subject based on a subject's health information, providing a personalized reminder to a subject to access personalized health educational content from an educational module or perform a health-related activity, and providing a credit for a subject's accessing of personalized health educational content, wherein one or more credits can be redeemed for a reward. The personalized reminder can be customized to the needs and relevance of each user, and can be triggered by the subject or a clinician and delivered by one or more means of effective delivery. The personalized health educational content can comprise, for example, information about a disease or information about a medical test. Non-limiting examples of accessing of personalized health educational content includes reading an article, taking a quiz, or watching a video. Health information of a subject can be derived from any suitable source, non-limiting examples of which include EMRs, PMRs, and clinician input.

The present invention also provides a system for the use of the platform by health care payers to increase compliance and engagement of their members in programs offered by the payers.

Users of the invention can educate themselves about primary prevention, chronic care, and health IT tools, changing behaviors, timely screenings, diet, exercise, health-conscious decisions, and other health-related aspects of their lives in a personalized, customized, convenient, and enjoyable manner, which improves subject compliance, and consequently improves the outcome and productivity of the health education efforts.

The health care community faces a critical need for a method that promotes involvement of individuals in managing their current, or improving their future, health and medical conditions. The present invention addresses a need facing subjects with regard to health education today, including, for example, lack of engagement of the individual or subject, lack of convenience, lack of personalization, lack of relevance and motivation, and lack of compliance.

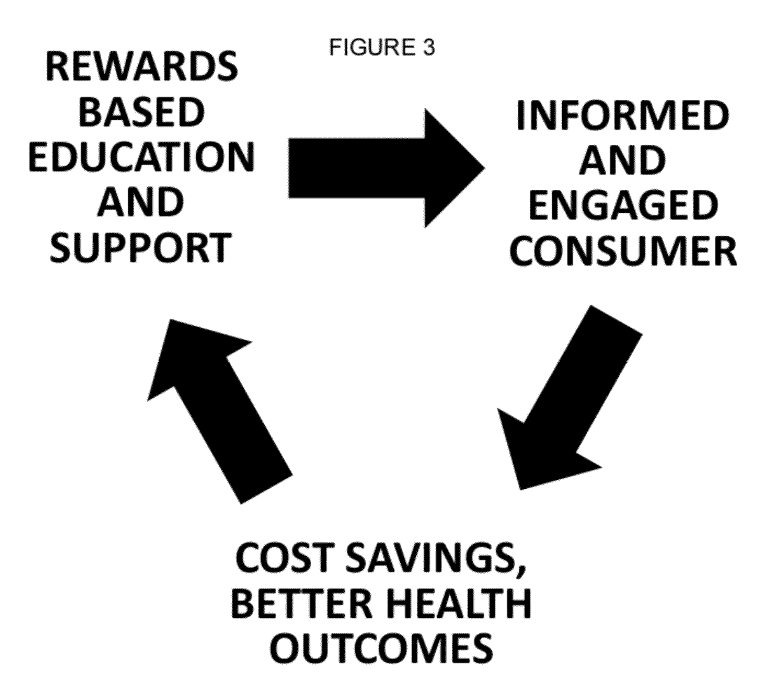

Provided herein is a system of health education and a method of providing and using the system that meets this need. The present invention relates to a personalized video education system and method for encouraging participation in an education program that can use personalized health maintenance reminders as part of an integrated health education and support platform that allows individuals to increase their knowledge and engagement in their health care and disease management (FIG. 3). Provided herein is a system of health education with more relevant and personalized health information, and a method of providing the health information in an interesting and interactive way. Thus, the present invention meets this need of promoting a healthier lifestyle, along with related advantages.

In one embodiment, the health care system disclosed herein comprises a highly organized, specific and integrated system that can provide timely health maintenance reminders and personalized educational content to a subject based on their health history, concerns, or a pre-existing disease or condition.

A subject can be an elderly adult, adult, teenager, child, or baby. In some embodiments, a subject can include a consumer, employee, individual, or patient. Non-limiting examples of a subject include a person with or without a disease or condition, a person that has or is currently receiving a treatment, and a person that has not received, or is not currently receiving, a treatment. The educational content can be personalized, can be provided in video format, and can be integrated into a wellness program module. In one embodiment, a wellness program module can include one or more organizations' wellness programs, databases, and member portals. The wellness program module is operational to exchange information between other modules of the present disclosure.

In some embodiments, an organization can include a health care provider, a company providing educational content to a subject, or a third party company. A health care provider can be an individual or an institution that provides preventive, curative, promotional, or rehabilitative health care services in a systematic way to individuals, families or communities. In some embodiments, an individual health care provider may be a health care professional, an allied health professional, a community health worker, or another person trained and knowledgeable in medicine, nursing or other allied health professions, or public/community health. Non-limiting examples of institutional health care providers include hospitals, clinics, primary care centers, hospices, convalescent homes, outpatient facilities, and other service delivery points when medical encounters occur.

A medical encounter can be a situation in which a subject divulges medical information to a medical worker, for example, a clinician, doctor, physician, nurse practitioner, hospital worker, specialist or physician assistant. A medical encounter can provide medical information such as: a complaint related to the nature and duration of a condition; the history of the subject's condition at the time of the medical encounter; a recitation of symptoms that a subject is experiencing; physical examination comprising one or more observations of the subject; vital signs and status of organs; muscle power; and/or diagnosis and recommendations for treatment.

Wellness programs can involve all aspects of the subject, for example, mental, physical, dietary, emotional, and spiritual aspects. Wellness programs can provide structured opportunities to increase knowledge and skills in specific areas, for example, stress management, or environmental sensitivity. Wellness programs help subjects understand the complexity of and ingredients for optimal psychosocial and physical well-being. In some embodiments, wellness programs can provide knowledge of proper exercise; for example, resistance training, endurance training, flexibility training, and balance training; nutrition; peer support; and the ability to cope with the psychological and physical health changes to a subject. Wellness programs can be helpful in promoting independence, functionality, health, and overall well-being in a subject. Furthermore, the present invention links that education with reminders, rewards, and incentives that can motivate subject behavior to avail themselves of the educational offerings.

The use of pharmacy medical credits (PMEs) can grant the subject satisfaction and one or more metrics that can be used to determine the level of knowledge, awareness, and even expertise a subject possesses about one or more health related topic or trend. A subject can achieve a higher PME credit score based on an effort by the subject, and subjects can see an immediate recognition and appreciation for the efforts they have put into to educating themselves about a health related program. Others types of programs may also be included. The proposed invention can also be extended outside the realm of healthcare to other areas and program like education, finance, and awareness of a trend or website or program.

In one embodiment, the present invention provides a subject-driven reminder system that can empower the subjects to participate proactively in health education efforts, which can improve the overall quality measures of health in a quick, safe, and efficient manner both within the individual health organization and the health of the population at large. This subject-based health reminder helps the current chronic disease subject population to significantly improve subject compliance. In addition to the subject being involved proactively in his/her health care; the present invention can also help with maintaining constant communication between the health care provider and the subject, in the interval period between medical encounters. This invention can also improve the subject's understanding of the chronic disease and improves the subject's self-efficacy in dealing with the chronic disease, and in turn improves the quality of the actual medical encounter, subject compliance, and the currently-recorded health care quality measures. In one embodiment, reminders about screenings and other health maintenance activities with associated education is delivered through one or more videos and articles online

### Personalized Education System

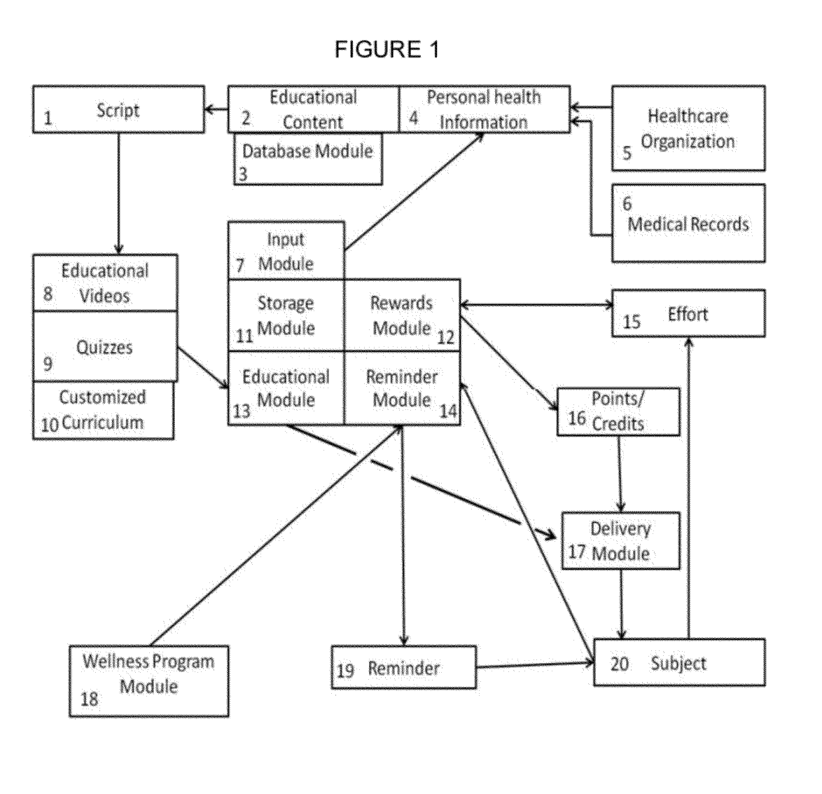

In one embodiment, health care engagement can comprise a personalized education system (FIG. 1). The personalized health education system can be a video education system, such as a personalized video education system. The health education system can comprise one or more educational videos and/or quizzes, for example health education videos. In some embodiments, health education videos further comprise multilingual support and/or support for the hearing impaired. The personalized education system can comprise a plurality of segments, such as at least 2, 3, 4, 5, 6, 7, 8, 9, 10, 11, 12, 13, 14, 15, 16, 17, 18, 19, 20, 21, 22, 22, 23, 24, 25, 26, 27, 28, 29, 30, 31, 32, 33, 34, 35, 36, 37, 38, 39, 40, 41, 42, 43, 44, 45, 46, 47, 48, 49, or 50 segments. The segments can each comprise an educational video (8), a quiz (9), or both. In some embodiments, a quiz corresponds to a video. The personalized education system can also comprise a user-input module (7) configured to receive personal information (4) of a subject (20), a customized script (1) for concatenation of two or more of the segments to generate personalized video education content based on the personal information of a subject; a delivery module (17) operable to deliver personalized video education content to the subject; a storage module (11) to store information about the subject, or any combination thereof. In one embodiment, the personalized video education system can comprise one or more software. The software be combined and/or further partitioned to similarly develop and personalize health care education videos and/or quizzes on behalf of one or more subjects. Inputs to the subject driven reminder system can be received form a subject (20), from a health care organization (5), from one or more user input devices, clinician input devices, medical records (6), such as EMRs and PMRs, and/or retrieved from a database module (3).

### Educational Content

The education content of the present disclosure can be personalized, such that the content is tailored or specific for an individual or based on a subject's personal information or input. The education content can comprise a plurality of segments, wherein the segments can each comprise an educational video, a quiz, or both. In some embodiments, an educational video can comprise a talk given by one or more lecturers for a subject to listen, one or more text entries for a subject to read, and/or an animated picture/figure for a subject to visualize. The segments can be personalized for each subject based on the available health information of a subject. One or more of the segments, for example, educational content (2), are stored in a database module (3) operational to communicate with an educational module (13). Upon entry of a subject's general and health information (4), a customized script (1) can generate a series of one or more personalized segments available to the subject to interact through the educational module based on the subject's general and health information. The segments can comprise one or more educational videos (8) and/or quizzes (9) related to health and medical topics, which can comprise one or more customized curriculums (10) for the subject (20). As a non-limiting example, for a subject with HDL and LDL levels indicative of risk for hyperlipidemia or cardiovascular disease, a family history of high cholesterol levels, and an above normal body mass index (BMI), the script may generate a series of one or more educational videos relating to informing the subject about cholesterol types and how to control cholesterol levels and quizzes to test a subject's comprehension of the educational material in the personalized education videos.

Non-limiting examples of the health and medical topics contained within the educational video include: autoimmune diseases; blood disorders; cancer/neoplastic diseases; cardiovascular disorders; dental and oral diseases; digestive disorders; ear; nose and throat diseases; endocrine and diseases; eye diseases; genetic and rare diseases; immune system disorders; infectious diseases; mental health disorders; musculoskeletal and bone disorders; neurological diseases; nutritional and metabolic diseases; parasitic diseases; pediatric disorders; respiratory and pulmonary disorders; rheumatological disorders; dermatological conditions; urological and kidney diseases and conditions; allergies; for example, allergy proofing your home, anaphylaxis, chronic rhinitis, cold and flu allergy, food allergy, hives, latex allergy, and sinusitis; Alzheimer's disease, for example, Alzheimer's warning signs, bladder incontinence, and dementia; arthritis, for example, ankylosing spondylitis, fibromyalgia, gout, lupus, osteoarthritis, psoriatic arthritis, reactive arthritis, and rheumatoid arthritis; asthma, for example, air filtration, asthma, asthmatic complexities; blood pressure; cancer, for example, cancer causes, cancer detection, brain tumors, bladder cancer, breast cancer, cervical cancer, colon polyps, liver cancer, lung cancer, pancreatic cancer, prostate cancer, skin cancer, and testicular cancer; cholesterol, for example, cholesterol profile (HDL/LDL levels, fiber, heart attack, and stroke prevention; chronic pain acupuncture, acute and chronic pain, cortisone injection, degenerative disc, and low back pain; cold and flu, for example, aches, pain, fever, chronic cough, cold, flu, common cold, encephalitis and meningitis, eustachian tube problems, flu (influenza), flu vaccination, immunizations, pneumonia, pneumonia vaccination, sars, sinusitis, sore throat, strep throat, swine flu, tonsillitis and adenoiditis; depression, for example, bipolar disorder, depression, dysthymia, panic disorder, post traumatic stress disorder, seasonal affective disorder, and stress; diabetes, for example, diabetes mellitus, diabetic home care and monitoring, diabetes insipidus, diabetes treatment, insulin, insulin pump; digestion, for example, abdominal pain, appendicitis, ulcerative colitis, constipation, crohn's disease, diarrhea dyspepsia (indigestion), inflammatory bowel disease, intestinal gas, gerd (heartburn, acid reflux), hemorrhoids, irritable bowel syndrome, lactose intolerance, laxatives for constipation, motion sickness, and ulcerative colitis; disease prevention exercise and activity, first aid, home and family, nutrition: healthy eating, and obesity; eyesight, for example, cataracts, eye allergy, eye care, glaucoma, lasik eye surgery, macular degeneration, pink eye (conjunctivitis), retinal detachment, and sjogren's syndrome; health and living; healthy kids; hearing and ear; heart angina, for example, atherosclerosis prevention, congenital heart disease, coronary angiogram, coronary angioplasty, coronary artery bypass, heart attack, heart murmurs, heart palpitations, high cholesterol, and stroke; hepatitis, for example, cirrhosis of the liver, essential mixed cryoglobulinemia, hepatitis b, hepatitis c, hepatitis a and b immunizations, jaundice, and lichen planus; high blood pressure (hypertension), for example, high blood pressure treatment and pulmonary hypertension; HIV/AIDS; infectious disease, for example, botulism, dengue fever, mad cow disease, malaria, meningitis, MRSA, rabies, staph infection, thrush, West Nile virus; liver conditions, for example, cirrhosis of the liver, non-alcoholic fatty liver, hemochromatosis (iron overload), hepatitis B, hepatitis C, jaundice, liver blood tests, primary biliary cirrhosis, primary and sclerosing cholangitis; lung conditions, for example, asthma, chronic obstructive pulmonary disease, emphysema, lung cancer, pneumonia, severe acute respiratory syndrome, smoking and quitting smoking; medications; menopause, for example, hormone creams, hormone replacement therapy, hot flashes, alternative treatments, and vitamin and calcium supplements; men's health, for example, angina, benign prostatic hyperplasia, erectile dysfunction, hair loss, prostate cancer, prostatitis, sexually transmitted diseases, testicular cancer, and vasectomy; mental health, for example, anxiety, body dysmorphic disorder, panic attacks, postpartum depression, separation anxiety, and stress; migraine, for example, cluster headaches, headache, migraine headaches and prevention, and tension headache; neurology; oral health; osteoporosis, for example, bone density, calcium supplements, estradiol, hormone replacement therapy, and menopause; pediatrics, for example, attention deficit disorder, bedwetting, birth defects, chickenpox, colic, diaper rash, lactose intolerance, nosebleeds, pink eye, measles, mumps, tonsillectomy, and vaccinations and immunizations; rheumatoid arthritis, for example, arthroscopy, Celebrex, cortisone injection, Remicade, rheumatoid arthritis, total hip replacement, and total knee replacement; pregnancy; senior health, for example, Alzheimer's disease, anemia, angina, cataracts, dementia, glaucoma, macular degeneration, hearing loss, heart attack prevention, sleep disturbance, and stroke; sexual health; skin, for example, acne, actinic keratosis, atopic dermatitis (eczema), boils, bumps and bruises, burns, dandruff, hives, itch, keloid, melanoma, nail fungus, poison ivy, psoriasis, rash (dermatitis), rosacea, scleroderma, shingles, skin cancer, warts, and wrinkles; sleep, for example, insomnia, insomnia treatment, jet lag, narcolepsy, sleep, sleep apnea, and snoring (somnoplasty); thyroid, for example, hashimoto's thyroiditis, hyperthyroidism, hypothyroidism, hypothyroidism during pregnancy, Synthroid, thyroid cancer, and thyroid nodules; urology, for example, bladder infection, bladder spasms, blood in urine, cystinuria, interstitial cystitis, kegel exercises for men, kegel exercises for women, kidney stone, nerve disease and bladder control, overactive bladder, prostatitis, urethral stricture, urinalysis, urinary incontinence in men, urinary incontinence in women, urinary retention, urinary tract infections, and urinary tract infections in children; travel health; women's health, for example, birth control, breast cancer, breastfeeding, hormone therapy, hysterectomy, menopause, miscarriage, osteoporosis, ovarian cancer, ovarian cysts, premenstrual syndrome, sexually transmitted diseases, uterine cancer, varicose veins, and yeast infections; weight loss, for example, anorexia nervosa, bulimia, calories burned during exercise, cellulite, childhood obesity, diet and weight loss, and obesity and weight loss; or a combination thereof.

### Quizzes

The personalized education system can comprise a plurality of segments, wherein the segments can each comprise an educational video, a quiz, or both. In one embodiment each quiz is operable to receive input from a subject through a user input module. In some embodiments, quizzes can be used to measure a subject's ability to retain simple knowledge and/or complex concepts, and/or assess a subject's ability to select a best possible answer from a list of answers. In some embodiments, the questions contained in the quiz relate to information that the subject had encountered previously, or recently, while using the health education system of the invention, for example, by viewing a video or reading an article.

In some embodiments, quizzes can comprise one or more questions. In one embodiment, the subject is asked to select from two options, for example, true or false. In another embodiment, a subject is provided a list of questions along with a list of answers and asked to determine each correct answer for each question, for example, a matching question.

In some embodiments, quizzes can be used to evaluate a subject's recognition of relationships between one or more words and/or definitions, events, dates, categories, and/or examples. In some embodiments, quizzes can be used to evaluate a subject's ability to organize, integrate, and interpret educational material. In some embodiments, quizzes can be used to evaluate a subject's preparation extent, ability to focus on broad issues, general concepts, and/or interrelationships. In some embodiments, quizzes can be used to evaluate a subject's progress, thinking quality, and/or depth of understanding. Non-limiting examples of forms of quizzes include multiple-choice, true-false, matching, performance, fill-in-the-blank, and flash cards. In an example of a multiple choice quiz, a subject is asked to select one or more best possible answers among the choices from a list, wherein the choices are stored in a database. In an example of a true-false quiz, a subject is asked to determine whether a provided statement is true or false. In an example of a matching quiz, a subject is asked to correlate one or more statements of a first list of statements to one or more items of a second list of items, wherein the items can be, for example, any of statements, images, videos, sounds, and/or informational content. In an example of a performance quiz, a subject is asked to demonstrate proficiency in conducting an experiment, executing a one or more series of one or more steps over time, following instructions, creating drawings, manipulating materials or equipment, or reacting to real or simulated situations. In an example of a fill-in-the-blank quiz, a subject is asked to complete an incomplete statement, wherein the subject can be required either: i. to select from a list of items to complete the statement; or ii. to input one or more words without a list of items. In an example of a flash cards quiz, a subject is shown one or more words, statements, questions, images, and/or videos for a short period of time followed by hiding the words, statements, questions, images, and/or videos wherein the subject is asked to answer a question relating to what the subject was shown. A quiz can comprise a lead-in question, for example, “What is the most likely diagnosis?” or “What pathogen is the most likely cause?”

In one embodiment, a correct answer earns a subject one or more points. In another embodiment, an incorrect answer earns a subject no points. In some embodiments, one or more points can be withdrawn from a subject for one or more unanswered questions, for example to penalize a subject for one or more incorrect answers. In another embodiment one or more points can be withdrawn from a subject for incomplete or incorrect answers, for example, to discourage random guessing and to promote the subject's interest in taking the quiz seriously.

### Computer System for Promoting Personalized Health Education

The system for promoting personalized health education can be operable to analyze the health information of a subject, provide personalized health education for a subject based on their health information, provide a personalized reminder to a subject, and provide one or more points redeemable for one or more credits for a subject's accessing of personalized health educational content. The system can also be operable to provide general training to subjects. In one embodiment, the system can be operable to provide compliance training, training to use the personalized health education system described herein, medical training, legal training and computer training.

Various computer systems are suitable for the operation of the systems outlined in FIG. 1. Such computer systems can have one or more input devices to receive input from a subject. Non-limiting examples of input devices include a mouse, a keyboard, a joystick, a microphone, and a touchpad. The computer can include a processor. The processor of the computer is operable to execute one or more sets of instructions contained in software. The system for promoting personalized health education includes software instructions in accordance with the present disclosure. The software associated with the system for promoting personalized health education can be installed to the computer or run by the processor of the computer from a storage medium. In various other embodiments, software associated with the system for promoting personalized health education can be downloaded via the internet or run from a remote location, such as from a remote server.

A module can be computer-executable program stored on a computer-readable storage medium. Modules can provide information to one or more storage or database modules and can execute one or more sequences of instructions, wherein execution of the one or more sequences of instructions by one or more processors embodied therein can cause the one or more processors to perform a method for providing information to the storage module or database module over a network. A network can comprise any type of wired or wireless communication channel capable of coupling together data and information from one or more modules. A network can be a local area network, a wide area network, or a combination of networks. In one embodiment of the present disclosure, a network can include the Internet. In some embodiments of the present invention, a network can be phone and or cellular phone network. A database module can comprise any type of means of storing data. This includes, but is not limited to, magnetic, optical, or magneto-optical based storage devices, as well as storage devices based on flash memory and/or battery-backed up memory. In one embodiment, a database module can be coupled to one or more modules of the present disclosure through a network.

Modules can be implemented in software for execution by one or more various types of processors. A module of executable code can comprise, for example, one or more physical or logical computer instruction blocks. In one embodiment, for example, a module can comprise an object, procedure, and/or function. In one embodiment, executables of a module can be physically located separately, for example, disparate instructions stored in different locations which, when joined together, can comprise an operational module. In one embodiment, executables of a module can be physically located together, for example, on the same computer system.

The computer system for promoting personalized health education can comprise one or more user input modules. The user input modules are operable to receive input from a subject regarding their personalized health information. In one embodiment, the user input modules can comprise an information module, a disease module, or an activities module, or a combination thereof. The subject communicates with the system for promoting personalized health education via user input modules.

The user input modules are operable to communicate with and store subject input information, for example, personal health information, to one or more storage modules within the system. The storage modules are operable to communicate with a database module and exchange information. The computer can comprise one or more storage modules. The one or more storage modules can comprise at least one of random access memory (RAM), read only memory (ROM), a cache, a stack, or the like, which may temporarily or permanently store electronic data of the computer. The user input modules can include one or more user management interfaces, client management interfaces, recipient configuration interfaces, data export interfaces, curriculum assignment interfaces, and reward redemption interfaces. The user interfaces can include one or more curriculum interfaces and data export interfaces.

The computer system for promoting personalized health education can comprise one or more storage modules. The system for promoting personalized health education is operational to allow data transfer and communication between storage modules, and one more other modules of the system, for example, a user input module, database module, and/or educational module (10) of the personalized video education system. A storage module can comprise one or more storage mediums and is operational to store information which can be communicated to a plurality of electronic devices, one or more other storage modules, educational modules, and/or user input modules. Non-limiting examples of storage media include one or more types of physical media including floppy disks, optical discs, DVDs, CD-ROMs, microdrives, magneto-optical disks, holographic storage devices, ROMs, RaMs, EPROMs, EEPROMs, DRaMs, PRaMS, VRaMs, flash memory devices, magnetic or optical cards, nano-systems; paper or paper-based media; and/or any type of media or device suitable for storing instructions and/or information. Various embodiments include a computer program product that can be transmitted in whole or in parts and over one or more public and/or private networks wherein the transmission includes instructions and/or information which can be used by one or snore processors to perform any of the features presented herein.

In one embodiment, the system for promoting personalized health education communicates with a plurality of electronic devices that can be used by health care providers or subjects. The health care providers can be employed by or associated with a subject. Such electronic devices can include, but are not limited to, a laptop, a work station, a personal digital assistant (PDA), a desk top computer, or a cell phone. Each electronic device is associated with one or more input devices used by the health care providers or subjects to communicate with the personalized video education system. These input devices can include, but are not limited to, a mouse, a keyboard, a joystick, a microphone, and a touch-pad. Insofar as the present disclosure is concerned, communications between the health care education management system, the computer, and/or the electronic devices, can be according to any known communication protocol including, but not limited to, USB, Wi-Fi, Bluetooth, TCP, and IEEE.

### Subject Health Information

In one embodiment, the personalized video education system can include a user input module. The user input module can receive as input, personal parameters of a subject, In some embodiments, personal parameters of a subject can comprise personal health information, clinician input, medical records, such as Electronic Medical Records (EMRs) and/or Pharmacy Medical Records (PMRs), which can be retrieved from a database module.

In some embodiments, personal health information of a subject can comprise general information about the subject, medical history, medical encounter history, existing disease information, and pertinent information regarding recent activities. In some embodiments general information about the subject includes, but is not limited to, age, sex, blood type, family history, height, and weight. In some embodiments, existing disease information can include but is not limited to BMI; risk for diabetes mellitus (DM) and pre-DM, for example, family history, weight, and/or diet; risk for Pre-hypertension (HTN), for example, systolic and diastolic blood pressure measurements, salt intake, microscopic urinalysis, proteinuria, serum blood urea nitrogen and/or creatinine levels, calcium levels, thyroid-stimulating hormone (TSH) levels, blood glucose, total cholesterol, HDL and LDL cholesterol, triglycerides, hematocrits, electrocardiograms, and/or chest radiographs; metabolic syndrome; hyperlipidemia, for example, HDL and LDL levels; risk of infection, for example, decreased immune system, compromised circulation, compromised skin integrity, or repeated contact with contagious agents; and/or cancer screening, for example, CAT scans and/or MRIs. In one embodiment, pertinent information regarding recent subject activities includes, but is not limited to, nutritional intake, for example, a diet diary log. In one embodiment, pertinent information regarding recent subject activities includes exercise extent, for example, pedometer readings. In one embodiment, pertinent information regarding recent subject activities includes psychological parameters, for example, anxiety, depression, psychosocial crisis, suicidal ideation, and or stress levels. As a non-limiting example, for a subject with HDL and LDL levels indicative of risk for hyperlipidemia, who only exercises one hour a week, and has a stressful job, the script can generate a series of one or more educational videos relating to informing the subject about physical activities that can be performed to reduce stress and lower cholesterol levels, foods to be included in a healthy diet to control cholesterol levels, and quizzes to test a subjects comprehension of the subject matter in the personalized education videos.

In one embodiment, the system for promoting personalized health education can collect subject health information through one or more user input modules operational to receive information from a subject through the use of a question interface. In one embodiment, the question interface displays questions operational to receive the health information of a subject based on one or more answers received by a subject, for example, “how old are you?”, “how much do you weigh?” and, “have you had children?”

Electronic Medical Records (EMRs) can relate to records obtained and stored by a subject's doctor, clinician, insurance company, hospital and/or other facilities where a subject is a patient. In some embodiments of the present invention, the doctor can include a medical doctor, a dentist, an optometrist, a therapist, a chiropractor, and anyone else who provides healthcare services to the subject within the medical field. In some embodiments, EMRs are can comprise digital records stored in a graphic format or pdf format, for example: doctors' notes to x-rays or other test results, for example, ultrasounds or MRIs; blood tests, for example, complete blood count; radiology examinations, for example, X-rays; pathology, for example, biopsy results; and/or specialized testing, for example, pulmonary function testing.

In another embodiment, EMRs can comprise digital records, for example, CAT scans, Mills, ultrasounds, blood glucose levels, diagnoses, allergies, lab test results, EKGs, medications, daily charting, medication administration, physical assessment, admission nursing notes, nursing care plan, referral, present and past symptoms, medical history, life style, physical examination results, tests, procedures, treatment, medication, discharge, history, diaries, problems, findings, immunization, admission notes, on-service notes, progress notes, preoperative notes, operative notes, postoperative notes, procedure notes, delivery notes, postpartum notes, and discharge notes.

A subject's medical history can refer to a medical record of what has happened to the subject since birth. For example, medical history can be a record of diseases, major and minor illnesses, and/or growth landmarks. In one embodiment, medical history can comprise surgical history. Surgical history can describe surgery performed on a subject, for example, dates of operations, operative reports, and/or the detailed narrative of what a surgeon performed.

In one embodiment, medical history can comprise obstetric history. Obstetric history can comprise prior pregnancies, pregnancy outcomes and/or pregnancy complications. In one embodiment, medical history can comprise medications and medical allergies, for example, a subject's current and previous medications and/or medical allergies.

In one embodiment, medical history can comprise family history. Family history can comprise one or more lists of immediate family members' health status, for example, causes of death, diseases common in the subject's family or found only in one sex or the other, and/or a pedigree chart.

In one embodiment, medical history can comprise social history. Social history can comprise one or more chronicles of a subject's human interactions, for example, relationships of the subject, a subject's careers, trainings, schooling, and/or religious training. In some embodiments, social history can provide information regarding community relationships support the subject can expect for a particular disease, provide information that can explain one or more behaviors of a subject in relation to one or more illnesses or losses, and/or can provide information to aid in a determination of one or more causes of one or more illnesses, for example, occupational exposure to asbestos. In one embodiment, medical history can comprise habits which can impact a subject's health. Habits which impact health can comprise, for example, tobacco use, alcohol intake, exercise, diet, sexual habits, and/or sexual orientation. In one embodiment, medical history can comprise immunization history Immunization history can comprise a history of a subject's vaccinations, and/or blood tests providing immunity data.

In one embodiment, medical history can comprise one or more growth charts and developmental history. For example, if the subject is a child or teenager, growth charts and developmental history can comprise one or more charts documenting a subject's growth and/or a comparison to other subject's of the same age. In some embodiments, growth chart and developmental history can provide information for the cause of an illness because many diseases and social stresses can affect growth and development of a subject. In another embodiment, growth chart and developmental history can comprise information regarding a child's behavior, for example, timing of talking, and/or timing of walking, and/or a comparison to other children of the same.

Pharmacy Medical Records can relate to records pertaining to a subject's pharmacological history. In one embodiment, pharmacological history can comprise a subject's prescription history, current prescription regimen, and side effect information, for example, dosage information, length of time a subject has been taking a prescription, and other drugs known to cause negative side effects with a subject's current prescription regimen.

### Educational Module

An educational module of the personalized health education system can generate a plurality of personalized segments, each comprising one or more educational videos and quizzes, based on a subject's health information. A customized script can be utilized to concatenate two or more inputs, such as 3, 4, 5, 6, 7, 8, 9, 10 or more inputs to generate personalized video content based on the personal information of the subject. In one embodiment, the customized script converts the subject's input to configuration data for processing by the personalized video education module. The educational module of the computer system for promoting personalized health education is operable to communicate and exchange subject health information from one or more storage modules within the computer system and one or more database modules of the personalized video education system. The subject's personal health information is operable to provide information to generate personalized video education content and/or one or more customized curriculums for the subject.

In one embodiment, the personalized video education content is stored in a storage module. In another embodiment, the personalized video education content is stored in a database module. The educational module can generate the plurality of personalized segments for display on the user interface by the computer and the electronic devices. In various embodiments, the educational module translates the interface data into a web programming language such as, but not limited to, HTML, XML, PHP, ASP, and Perl. The translated interface data along with predefined interface data can make up the various interfaces. One or more segments can comprise information, for example, health information such as state of the art, updated health education information from reliable organizations and/or sources, such as Center for Disease Control (CDC), National Institutes of Health (NIH), or American Diabetes association (ADA), and offer web links. In another embodiment, the educational module can comprise one or more portals for marketing and ads for new health services provided by the organization or source.

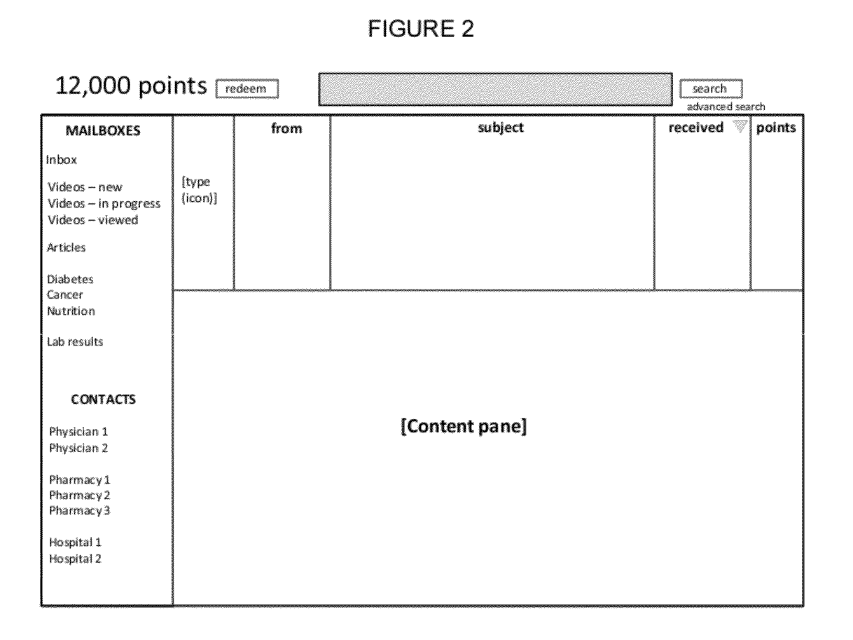

The educational module is operable to display an interface within the computer system and receive input from a subject. In one embodiment, the interfaces can comprise a means operable to provide the subject educational videos, provide quizzes/tests, display an interactive table of contents, provide a review of a subject's test results, and store test results (FIG. 2).

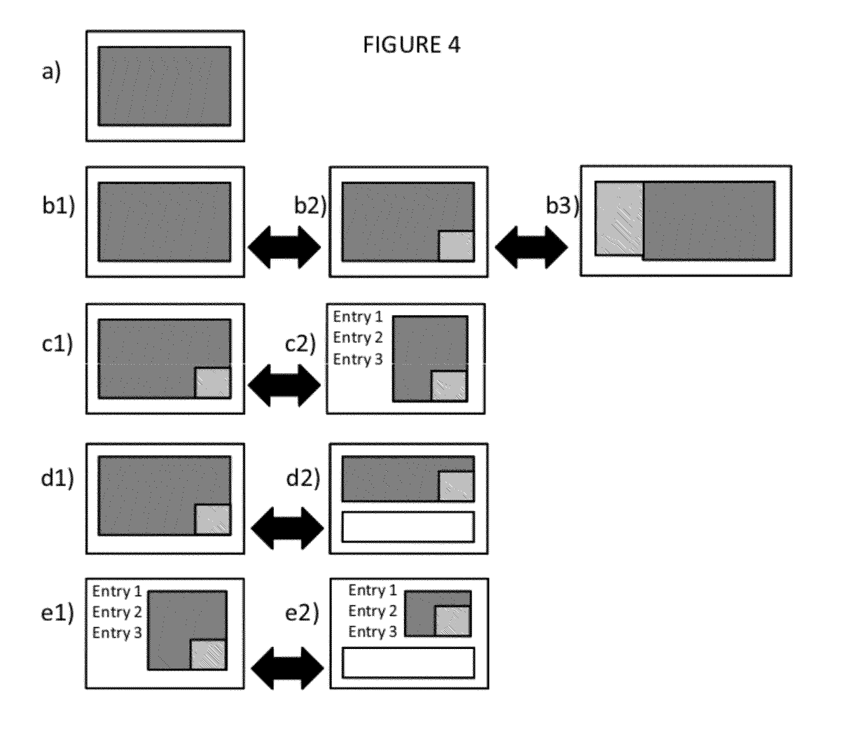

Illustrative examples of interfaces are depicted in FIG. 4. The interfaces are dynamic, and the subject can conveniently switch among interfaces as desired or as is most productive for viewing content. FIG. 4a illustrates a slide, which is the overall framework within which the content is displayed. FIG. 4b illustrates three examples of video display modes, hidden (FIG. 4b1), inset (FIG. 4b2), and large (FIG. 4b3). The table of contents can be hidden (FIG. 4c1) or displayed (FIG. 4c2). The user can hide (FIG. 4d1) or show (FIG. 4d2) an information panel while the table of contents is hidden. The user can hide (FIG. 4e1) or show (FIG. 4e2) an information panel while the table of contents is displayed.

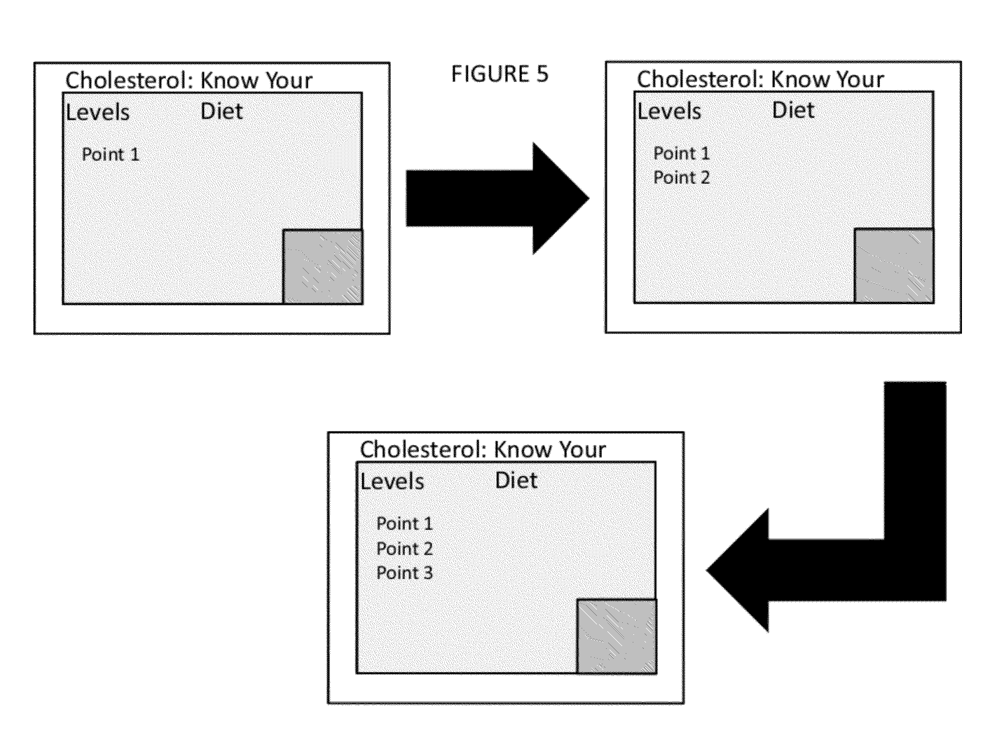

In one embodiment, the educational module comprises a video display interface. As the video plays, a list of points can appear on the slide. Each point represents a benchmark within the video, beyond which the subject has progressed. In some embodiments, each point appears one at a time as a dietary instructional video, entitled, “Cholesterol: Know Your Levels,” plays in the lower right-hand corner, as illustrated in FIG. 5. The subject can have the option to return to any one of the points that has appeared on the slide by clicking on the point.

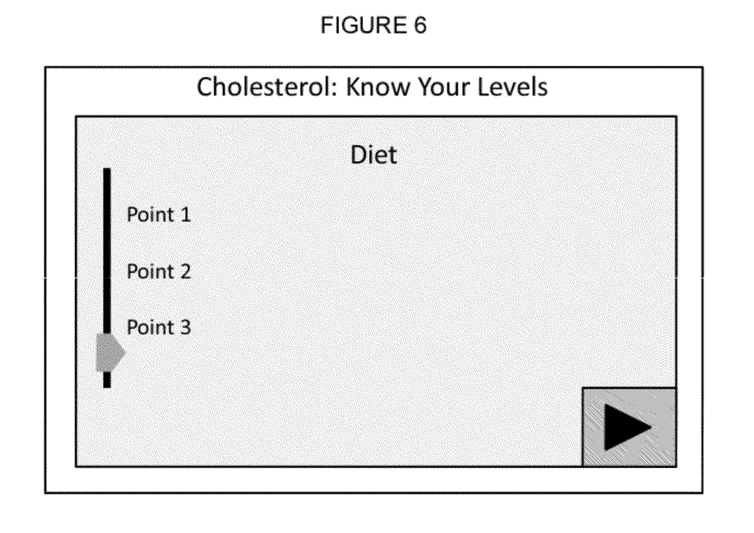

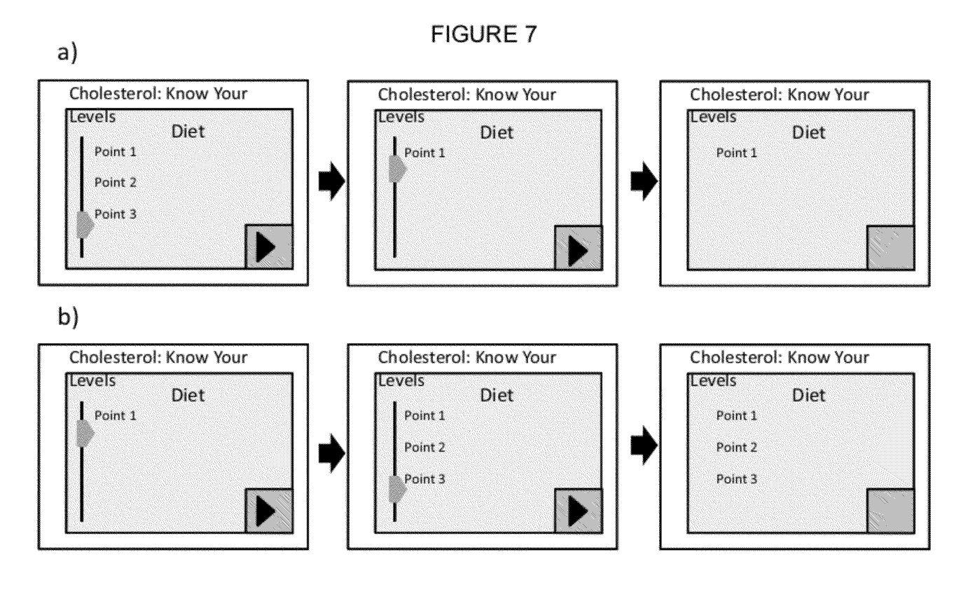

In one embodiment, the video display interface can be controlled by the subject. If the subject clicks anywhere while the video is playing, the video can be paused. A progress bar can be displayed on the left or right edge of the slide. In one embodiment, a progress bar can extend to one or more parts of the slide of which the subject has and/or has not viewed. In one embodiment, a progress bar can extend only to the last part of the slide of which the subject has viewed. In one embodiment, a play symbol is shown in the video pane. In one embodiment, the play symbol can appear if it had been hidden, as illustrated in FIG. 6. The subject can have the ability move the progress bar either up or down, or a combination thereof, and the video can be rewound or fast-forwarded. In one embodiment, the subject can activate the play button. In one embodiment, the video resumes playing at the chosen location. In some embodiments, points can be displayed next to the progress bar to indicate viewable content. In some embodiments, as the progress bar is moved up, points above the progress bar location disappear, as illustrated in FIG. 7a. In some embodiments, as the progress bar is moved down, points indicating content that has already been viewed reappear, as illustrated in FIG. 7b.

In one embodiment, the video display interface can be programmed to display focused parts or specific topics of the educational content. The video display interface can be programmed to play specific time slots within videos, specific slides of educational content, or specific quizzes or questions of a quiz. The video display interface can be programmed to display specific topics of the educational content. For example, the video display interface can be programmed to display educational content related to a disease of a subject viewing the educational content.

In one embodiment, educational content can be tagged with information for a subject to view while viewing the educational content. In one embodiment, drug codes (National Drug Code Directory) and patient visit codes can be tagged to educational content, such as videos, slides, and quizzes. For example, a health care professional, such as a doctor, can tag a video within the educational content with a drug code to a drug prescribed to a subject after a visit with the doctor. The visit of the subject with a health care professional can thereby be integrated into the educational content. In one embodiment, codes or information pertaining to prescriptions, medications, and drugs can be tagged to educational content personalized to the subject to integrate the codes or information pertaining to prescriptions, medications, and drugs with a visit of the subject to a health care professional. The subject can view the tags and information from the health care professional while viewing the educational content and can increase the level of personalization of the educational content to the subject.

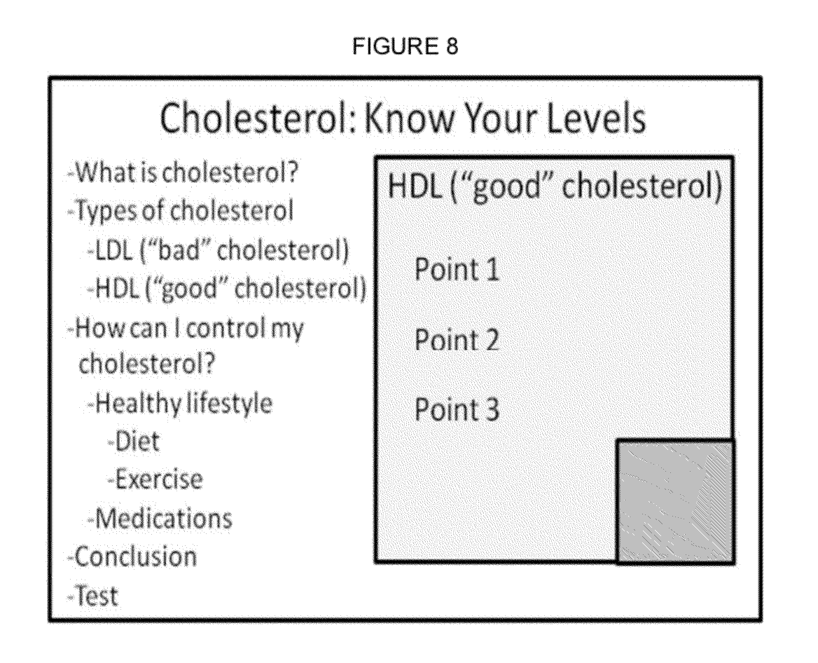

In some embodiments, the Table of Content (TOC) can be operable to indicate the current slides of the subject. In one embodiment, the TOC indicates the current slides by displaying a unique color. In one embodiment, the TOC indicates the current slides by displaying a color, for example, red. In some embodiments, the TOC can be operable to indicate slides to which access to the subject is denied. In one embodiment, the TOC indicates the slides to which access to the subject is denied by displaying a unique color. In one embodiment, the TOC indicates the slides to which access to the subject is denied by displaying a color, for example, grey. In some embodiments, the TOC can be operable to indicate slides to which the subject has access. In one embodiment, the TOC indicates the slides to which the subject has access by displaying a unique color. In some embodiments, the TOC indicates the slides to which the subject has access by displaying a color, for example, black. In one embodiment, the slides accessed by the subject contain the videos accessible to the subject. FIG. 8 illustrates a slide, listing, on the left side, a TOC listing a series of videos viewed by the subject.

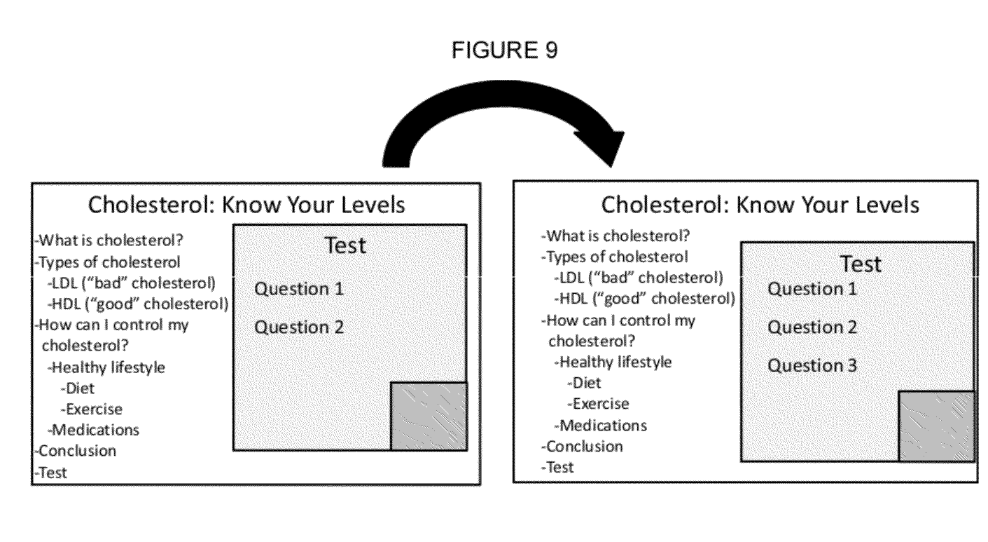

In some embodiments, while the subject is answering quiz questions, only the slides comprising the quiz questions are accessible by the subject. As illustrated in FIG. 9, during a quiz, the questions are presented one at a time, the subject can click on a previous question to read the previous question again, and the subject can view the TOC. In some embodiments, upon completion of quiz questions, the subject is granted access to one or more other slides.

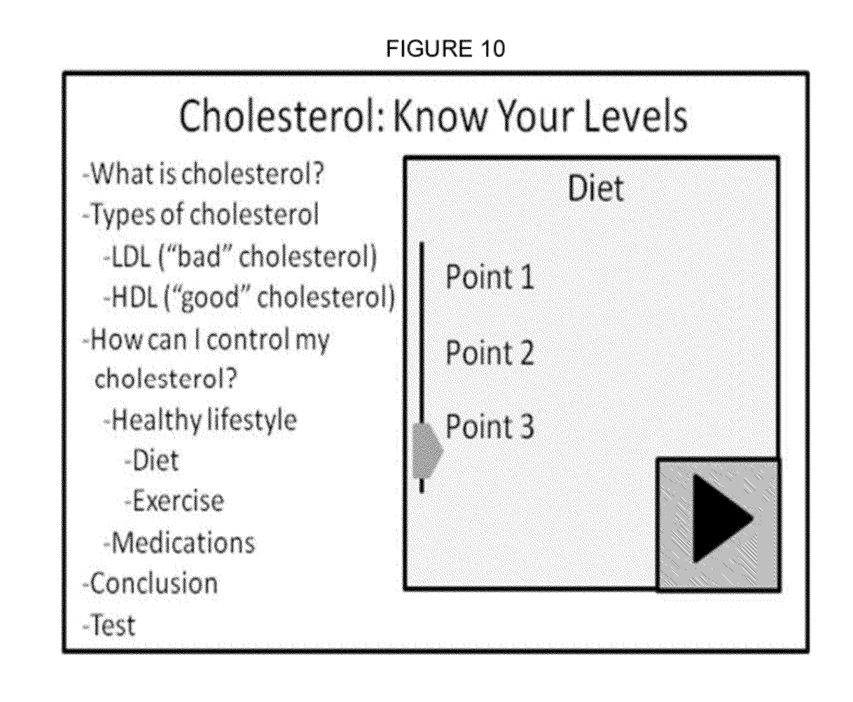

In one embodiment, a subject can provide input into the TOC to access one or more accessible slides. In one embodiment, a subject can left click on one or more slides displayed in the TOC to view one or more slides. In one embodiment, the new slide is displayed upon subject input into the TOC. In one embodiment, a progress bar can be displayed, for example, to indicate the last position viewed. In one embodiment, a subject can be granted access to resume playing a video at any point within the video that has already been viewed by the subject. FIG. 10 illustrates a slide wherein the subject has paused the video. The progress bar has appeared to indicate at what position in the video the subject stopped, and what points have been passed. The subject can resume playing by clicking the “play” icon in the lower-right-hand corner.

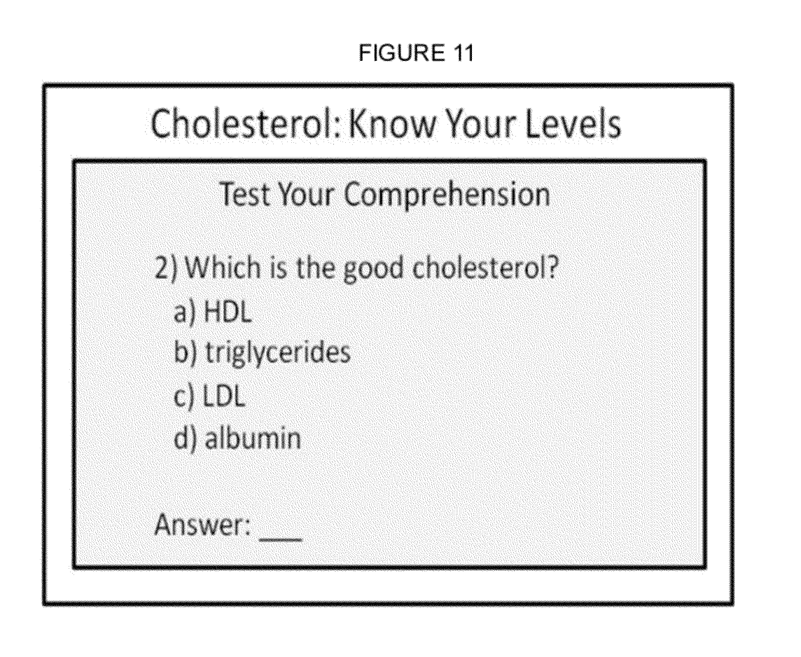

In one embodiment, providing quizzes can comprise displaying one or more quizzes throughout a video. In another embodiment, one or more quizzes are displayed upon completion of the video. In one embodiment, a quiz can comprise one or more questions. In one embodiment, a quiz comprises only one question. In one embodiment, when one or more quizzes are currently displayed, a subject is denied access to any other slides. FIG. 11 provides an example of a slide displaying a quiz question.

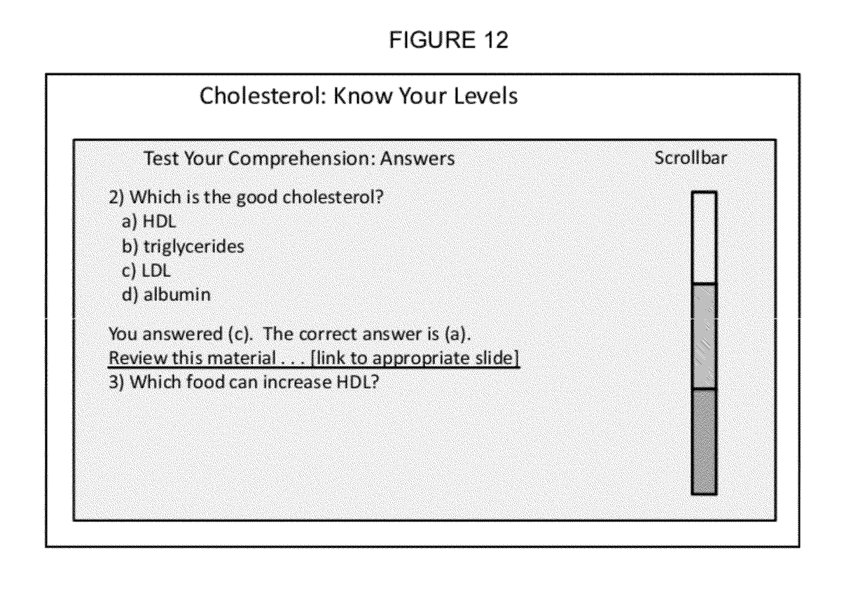

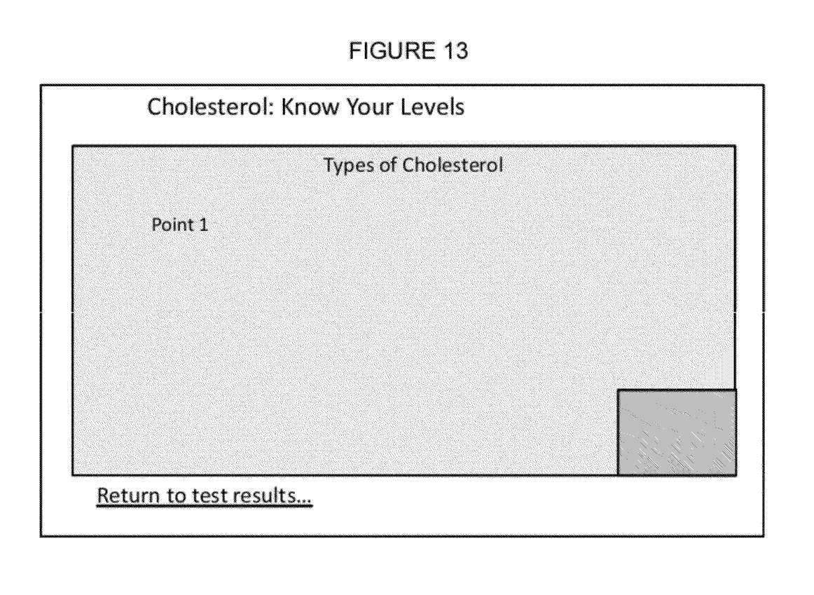

In one embodiment, upon a subject's completion of one or more quiz questions, one or more answers to questions, and optionally a rationale for the one or more answers, can be displayed, as illustrated in FIG. 12. The subject can scroll through the questions and answers using a scrollbar. In one embodiment, one or more links associated with the respective educational video content and/or quiz questions can be provided for the subject to access. In some embodiments, one or more links operable to accession by a subject are displayed within the TOC. In one embodiment, accession by a subject results in the display of one or more appropriate slides and educational videos, which can begin playing. In one embodiment, one or more of the links is displayed as “review this material.” Such a link is a link to a slide with the appropriate material for reviewing information relevant to the question. In another embodiment, the subject can return to one or more test results by clicking a link, for example a link displaying “return to test results” as illustrated in FIG. 13, located at the bottom, top, left, right, or middle, or a combination thereof, of the screen, or within the TOC to return to one or more quizzes.

In one embodiment, a subject can take notes while accessing the educational module. The subject can input notes, for example by typing notes, within the educational module. In one embodiment, the subject can take notes while watching an educational video or when an educational video is paused. In one embodiment, the subject can take notes while learning or taking a quiz.

In one embodiment, a subject can communicate with a health care professional, such as a doctor or a trainer while watching videos, viewing slides, or taking quizzes. The subject can communicate with a health care professional through a messaging system, email, or any other communication means that is integrated into the educational module. For example, the subject can type questions or messages for a doctor to answer or read into an integrated messaging system and send the doctor the questions or messages. The doctor can respond to the questions or messages, thereby communicating with the subject.

In one embodiment, a subject can share educational content with other subjects. The subject can share videos, slides, and quizzes with other subjects. In one embodiment, the subject can send the videos, slides, and quizzes to another subject using a sharing system integrated into the educational module. The subject can share educational content with other subjects through a messaging system, email, or any other communication means that is integrated into the educational module.

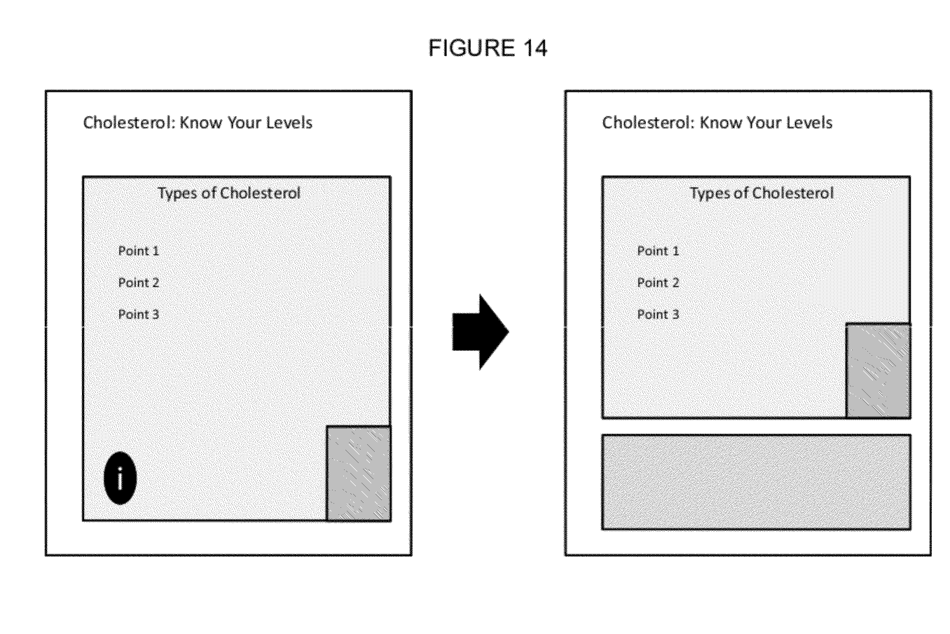

The educational module can display one or more information symbols located at the bottom, top, left, right, or middle, or a combination thereof. An example of an information symbol appearing in the lower left-hand corner of the slide is illustrated in FIG. 14. In one embodiment, the information symbols are links to other available relevant information. Relevant information can comprise, for example, definitions, articles, and videos. In one embodiment, if a subject accesses one or more information symbols, the associated available relevant information can be displayed in one or more other interfaces. FIG. 14 illustrates the opening of a second, lower, panel, upon clicking the information symbol. In one embodiment, the other interfaces can comprise, for example, a new browser window or a new browser tab. In one embodiment, upon accession of a second slide by the subject, the interface displaying the first slide is closed.

### Text Module

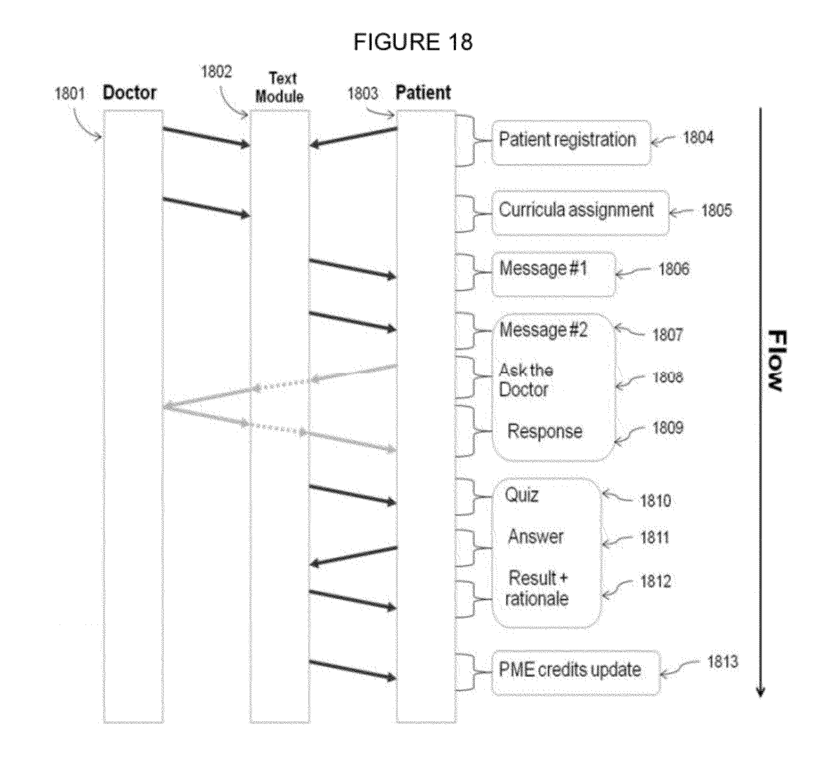

In one embodiment, the computer system for personalized health education can comprise a text module 1802, which can be operable to receive and send text messages between a user of the system (patient) and a health care provider (doctor) as shown in FIG. 18. In one embodiment, the text module 1802 can be operable to receive and display one or more text messages in an educational module, such in the videos or quizzes of an educational module. The text messages can be received and sent from a healthcare provider, such as a doctor 1801, and a user, such as a patient 1803.

In some embodiments, a patient 1803 can send a text message to the text module 1802 to register the patient 1804. A patient can specify a phone number for receiving text messages and can specify whether text messages, reminders, credit updates, and other information should be sent via email or to the phone number provided. In some embodiments, when a phone number is not provided by the patient, such as during registration 1804, text messages will be automatically sent to the patient via email.

In some embodiments, a doctor 1801 can assign one or more curricula to a patient 1805 by sending a text message to the text module 1802. In some embodiments, the information can be stored and accessed by the patient. In some embodiments, the curricula assignment information can be sent to a patient via a text message 1806.

In some embodiments, after receiving one or more messages from a sender, such as one or more text messages from a doctor 1807, a patient 1803, can reply or respond to a doctor 1801 with a question 1808. A response from a doctor 1809 can be forwarded to the patient 1803. In some embodiments, the body of the original message 1807 from the doctor can be included in the text message from the patient 1808, for example, so a doctor knows the context in which a question is being asked. A response from the doctor 1809 can be a message sent as a text message back to the patient in response to a question 1808. For example, a doctor can send a text message 1807 to a patient 1803 supplying information regarding heart health. After receiving the text, the patient can respond to the doctor with a question 1808 regarding cholesterol levels. The question 1808 from the patient can be received by the doctor and can contain the patient's question and can include the original text message sent from the doctor 1807. The doctor can send a text message response 1809 to the patient, for example, to answer the question provided by the patient.

In some embodiments, a text message can be a message, such as a string of words or text, or a quiz 1810. A quiz 1810 can be a single question followed by two or more choices for the answer to which a patient has time to reply with one of the answer choices 1811. The system can be operable to respond with a message 1812 indicating whether the answer chosen by the user is correct or incorrect and a rationale for why the answer is correct or incorrect, similar to the quizzes of the educational module described herein.

In some embodiments, the number of unredeemed credits can be sent to a user via one or more text messages 1813. A list of one or more rewards that can be redeemed by a user using the credits (assuming the patient has accumulated enough credits to redeem a reward) can be sent to a user via one or more text messages. Any of the text messages described herein can be sent periodically, or can be sent when the number of unredeemed credits reaches an upper threshold. For example, the text messages can be sent once every day, week, or month, or can be sent when the number of unredeemed credits of a user reaches 100, 500, 1000, 2500, 5000, or 10000 credits.

In some embodiments, the frequency at which any of the text messages described herein are sent can be determined by the doctor. For example, a doctor can specify to send a patient text messages containing health education information and quizzes once or twice every day, week, or month. In some embodiments, when the frequency at which to send text messages to a patient is not specified by a doctor, text messages will be sent to the patient twice a day by the text module 1802 based on the information stored for the patient.

In some embodiments, the frequency at which any of the described text messages are sent can be determined by the patient. For example, a patient can specify the frequency at which to send text messages supplying credit updates. For example, the patient can specify whether the text messages supplying credit updates are sent once every day, week, or month, or sent when the number of unredeemed credits of the patient reaches 100, 500, 1000, 2500, 5000, or 10000 credits. some embodiments, when the frequency at which to send text messages supplying credit updates to a patient is not specified by a patient, text messages will be sent to the once a week by the text module 1802 based on the credits information stored for the patient.

Any of the text message described herein can be added to a video of the educational module and can be displayed within a video. The texts can be displayed as a list within a video of the educational module. The list can be an ordered list. For example, texts can be displayed within a video of the educational module as follows:

1. You should get your cholesterol levels checked every year . . .
2. There are two types of cholesterol: good and bad. Good cholesterol . . .
3. QUIZ: How many types of cholesterol are there?

The user of the educational module can have control over the placement of one or more texts within a video of the educational module. For example, a user can have control over the position of one or more texts within a list, such as an ordered list described above. The user of the educational module can have control over which video or videos a text can be added. For example, a user can add a text regarding cholesterol types to a video about cholesterol, heart health, or both to one or more videos within an educational module. A user can delete one or more existing texts, insert one or more new texts, and update one or more existing texts within a video of an educational module.

In one embodiment, each text can be associated with a timestamp. A timestamp can indicate a point in time in a video after which a message can be sent to a subject. For example, if the timestamp for a text message is 4:35, the text message can be sent to the subject after the subject has watched at least the first 4 minutes and 35 seconds of the video. In one embodiment, a blank timestamp can default to the end of a video. For example, if the timestamp for a text message is blank, the text message can be sent to the patient after the patient has watched the entire video. In some embodiments, when a text is moved to a different position in a list, the timestamp associated with the moved text can replace the timestamp associated with the text following the moved text. In some embodiments when a text is moved to a different position at the end of a list, a blank timestamp can replace the timestamp of the moved text.

### Self Reminder Module

In one embodiment, as illustrated in FIG. 1, the system disclosed herein can comprise a reminder module (14). The reminder module can provide one or more reminders (19) that can keep a subject engaged, informed, up to date, and interested in health education. Keeping a subject informed can significantly increase subject engagement in healthcare education, thereby leading to better outcomes, greater interest in prevention and well-being, lesser need for restorative therapy, and lower per capita treatment costs. Health education and support can include subject and health education, prevention programs, chronic and non-chronic health conditions, and disease and preventative screenings, implementing any health care and wellness programs offered by companies, employers, healthcare payers, health IT programs, and adoption of personal health records. In some embodiments, the reminder module is triggered by the wellness program module (18).

The reminder system disclosed herein can comprise a web-based subject health reminder system which offers a link between personal health records (PHR) and electronic medical records (EMR). In one embodiment, this innovative subject health reminder system is subject-based. In one embodiment, the subject health reminder system is provider-based. In some embodiments, the subject health reminder system is both subject-based and provider-based.

In one embodiment, the disclosed reminder system can help improve the overall quality health measures quickly, safely, conveniently, and efficiently, both within one or more health organizations, and within the health of the population at large. In one embodiment, the subject-based health reminder can help the current chronic disease subject population to improve subject compliance significantly. In one embodiment, the reminder system can maintain consistent communication between health care providers and the subject, specifically during the period between medical encounters. In one embodiment, the personalized health system can improve the subject's understanding of chronic diseases and improve subject's self-efficacy with the chronic condition. In some embodiments, the improvement of the subject's understanding of chronic diseases can improve the quality of a medical encounter. The reminder system disclosed herein also improves subject compliance and contemporaneously-recorded measures of health care quality.

In one embodiment, the subject reminder system can comprise a user-friendly, web-based, and/or non-web based system that can be used with one or more health care organizations, one or more insurance companies, and/or one or more subjects in-between insurances. In one embodiment, the reminder system can be a one or more step process for the subject. In one embodiment, no effort is required from one or more healthcare providers; such a process allows easy adoption of a reminder system from one or more parties. The reminder system can comprise one more features. Non-limiting examples of features include reminders, information tracking, health information, marketing portals, and any combination thereof. In one embodiment, features can be personalized to an individual institution, individual provider, or an individual subject.

The reminders can comprise one or more tiers comprising health information of a subject. Upon subject input, one or more specific reminders associated with a tier and/or an input can be generated within the reminder module. Specific reminders can be stored in the storage module or database module.

In one embodiment, a subject can enter a health tracker interface, which can be operable to track a subject's nutrition, exercise effort, and stress levels. Subject input of pertinent information regarding recent activities can initiate one or more further reminders for health related activities, for example, exercise, dieting, or check-ups. In one embodiment, a subject's activities can include activities associated with a wellness program, for example, mental, physical, and spiritual activities of the wellness program. In one embodiment, reminders can be set to be delivered on a time frame desired, specified, or requested by the subject. In some embodiments, the desired time can be, for example, hourly, daily, weekly, monthly, and/or yearly. In one embodiment, reminders can be set to be delivered hourly, for example, once every 1, 2, 3, 4, 5, 6, 7, 8, 9, 10, 11, 12, 13, 14, 15, 16, 17, 18, 19, 20, 21, 22, 23, or 24 hours. In one embodiment, reminders can be set to be delivered daily, for example, once every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or 31 days. In one embodiment, reminders can be set to be delivered weekly, for example, once every 1, 2, 3, or 4 weeks. In one embodiment, reminders can be set to be delivered monthly, for example, once every 1, 2, 3, 4, 5, 6, 7, 8, 9, 10, 11, or 12 months. In one embodiment, reminders can be set to be delivered yearly, for example, once every 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 years.

The proposed reminder system can play a critical role in solving the healthcare crisis that primarily stems from a lack of subject engagement and compliance in the subject's healthcare. Areas of a subject's health that are improved by the reminder system include prevention, chronic care, health IT adoption, undergoing screenings, being aware and knowledgeable and making timely interventions and behavioral changes. The reminder system can simplify health education because the present invention includes video-based education regarding the associated reminders. This innovative and unique solution can help deliver significant healthcare cost savings and better health outcomes. Furthermore, the solution is scalable, for example, a system of the invention can support over ten million different curricula and one billion subjects.

### Reward or Credit Module

The personalized health education system can comprise a reward or credit module (12), illustrated in FIG. 1, which can award, for example, points or credits (16) to the subject based on an effort (15) of the subject. In one embodiment, the health education system can comprise a health maintenance reminder module (14) combined with a patient medical education credit (PME credits) or reward module. In some embodiments, the personalized health education system is operational to search for providers related to a subject's health screening, personalize advertisements, target highly relevant advertisements to the subjects, match relevant advertisements to highly relevant and likely subjects, introduce subjects to a dedicated and trusted video channel to educate subjects about the product, and deliver the highest quality of leads to marketers and service providers. Tying credits to reminders can also provide a reminder advertising channel for marketers and service providers. All of these features can be delivered while maintaining HIPAA level privacy for subjects.

The use of rewards and patient medical education credits as part of the reminder system is innovative and can be transformative. The present invention can allow subjects and healthcare payers to increase engagement and compliance in healthcare. Subjects can obtain and accrue patient medical education credits for an effort. In one embodiment, effort can comprise signing up for one or more personalized reminders, for example gaining 0-500 credits.

In some embodiments, effort comprises creating, and/or responding to one or more reminders in a timely fashion and/or keeping reminders up to date. In a further embodiment, additional credits can be given to subjects who can achieve deep personalization of reminders, for example, by integrating them into provider's EMRs.

In one embodiment, effort can comprise adoption of health IT and integrating their health engine into provider electronic medical records and pharmacy management systems. In one embodiment, effort can comprise learning about medication through medication reminders. In one embodiment, effort can comprise reading articles. In one embodiment, effort can comprise watching videos related to reminders. In some embodiments, effort can comprise filling one or more questionnaires or answering one more questions and taking one or more tests. In one embodiment, effort can comprise undergoing health screenings tests. In one embodiment, effort can comprise signing up for health maintenance reminders. In one embodiment, effort can comprise integrating to physician EMR reminders. In one embodiment, effort can comprise reading test results and watching videos explaining test results. In one embodiment, effort can comprise increased usage to ensure compliance is consistent and steady. In one embodiment, effort can comprise receiving product ads and disease and drug education via videos. In one embodiment, effort can comprise receiving reminders about drug education and redemption offers.

In some embodiments, effort can comprise participation in activities associated with a wellness program of an organization. As a non-limiting example, a subject's effort toward a wellness program can comprise participation in one or more smoking cessation programs, stress management programs, education programs, walking programs or challenges, support groups, informal sports leagues, weight loss programs, fitness center memberships, medical self-care training programs, wellness seminars, and/or health and wellness fairs.

In one embodiment, accrued credits or points accrued by a subject can be redeemed by the subject for, for example, one or more certificates, cash bonuses, cash rewards, health and wellness products and services, and other products and services, and discounts and other value added services, within a redemption network or a network of partners. In some embodiments, the redemption network or network of partners can include healthcare providers, employers, insurers, Medicare, Medicaid, international payers, health IT companies, and other consumer internet companies.

In one embodiment, redemptions can be done electronically, for example, by email, text messages, or web page. In another embodiment, redemptions can be done through mail or telephone.

Non-limiting examples of reward vehicles include cash, checks, bank drafts, bank accounts, stored value or prepaid debit purchasing cards, stored value or prepaid credits on cellular phones and/or PDAs, stored value or prepaid credits on biometric payment systems, stored value or prepaid debit payments made using gift certificates or unique alphanumeric identifiers such as gift certificates, vouchers and coupons. Other types of reward vehicles can be used. The designated purpose can be to purchase products and services in the health and wellness category or relating to a specific health and wellness need on the part of the subject, or can be some other purpose. Patient medical education credits can include, in some embodiments, use of loyalty points or credits given to a subject to educate themselves about health and wellness conditions, health IT tools, and systems. Other types of credits can be used. Health IT tools and systems can include personal health records, electronics medical records, activity diaries, or test results. Other types of health IT tools can be used. In some embodiments, the platform can include online systems of delivery and access of content including, for example, a laptop, computer system, PDAs, wireless and wired devices, and offline systems, for example paper, video, and other mediums of content delivery.

In some embodiments, a subject can redeem accrued points and credits for cash bonuses, cash rewards, health and wellness products and services and other products and services, and discounts and other value added services, within the redemption network or a network of partners. Redemptions can be done electronically (email, text messages, web page) or over mail or telephone. In one embodiment, a subject receives post test notification related education about the test through videos and articles explaining the results. In some embodiments, a subject receives and redeems credits for efforts, for example, watching videos or reading articles.

In some embodiments, the invention comprises a structured and ongoing subject reminder system that can be personalized, easy to use and understand, and delivered to subjects conveniently and continuously. The system is facilitated, for example, by email and by videos explaining each health maintenance screening. Personalization of the videos based on the subject's test results further engages the subject. Self health reminders to inform and reward the subject keep the subject up-to-date, linking reminders with EMRs and PHRs. The reminders thereby aid in solving one of the most critical problems in healthcare, the problem being empowering health care subjects to make better decisions about their health and wellness.

### EXAMPLES

### Example 1

### Educational Module Display to Subject

A subject with a risk for hyperlipidemia uses a computer to access content entitled: “Cholesterol: Know Your Levels.” As shown in FIG. 2, the table of contents is located on the left. A subject accesses links to the specified targets within the table of contents. The table of contents displays links to videos that a subject has already viewed, is in process of viewing, and has not viewed yet. These are labeled “Videos—new,” “Videos—in progress,” and “Videos—viewed,” respectively. Within the table of contents, links to articles related to a diabetes, cancer, and nutrition are displayed. Within the table of contents, lab results of the subject are also displayed. Within the table of contents, mailboxes, such as an inbox, of the subject are also displayed. The table of contents also displays links to the contacts of a subject including, for example, Physician 1, Physician 2, Pharmacy 1, Pharmacy 2, Pharmacy 3, Hospital 1, and Hospital 2. Within the educational module's interface, one can see that a subject has received a point total of 12,000 for various efforts by the subject as displayed in the upper left corner. A “redeem” link is provided for the subject to access various rewards for which the points can be redeemed.

The educational content (videos and quizzes) are displayed within the educational module's interface within the “Content pane” section. The subject can stop, start, pause, fast forward, or rewind videos displayed in the content pane, while maintaining access to the various other embodiments of the educational module. As a subject finishes watching a video or viewing a slide or taking a quiz of the cholesterol educational content, the next slide, video, or quiz opens within the content pane and the user can continue to progress through the curriculum. The subject answers questions to quizzes displayed within the content pane as well. Upon completion of a quiz, the test results are displayed to the subject. The subject accesses the “review your answers” link to view specific cholesterol related educational content related to the quiz question. Links to additional material are also accessible to the subject in order to access information from other sources related to cholesterol. To return to the test results, the subject accesses the “return to test results link” which is operational to display the current test results to the subject for ease of navigation through the educational module.

Various links to points within the cholesterol educational content are displayed and a subject can utilize the progress bar to access the various points. Above the content pane within the interface, reminders are displayed for the subject as a part of the reminder module. Information about from whom the reminders came from is displayed in the top, left-middle of the interface. Adjacent to this region resides the subject matter for the various reminders. Adjacent to this section, the receipt date of the reminders are shown. The sections describe above are sortable by their respective information. Immediately adjacent to the receipt date section, points received, for efforts made by a subject to the respective activity reminder, are displayed and contribute to the total amount of points a subject has accumulated. In the shown example, to the right of the “redeem” link is an operational search box functional for a subject to search for various educational content, reminder, contacts, and rewards.

### Example 2

### Computer System

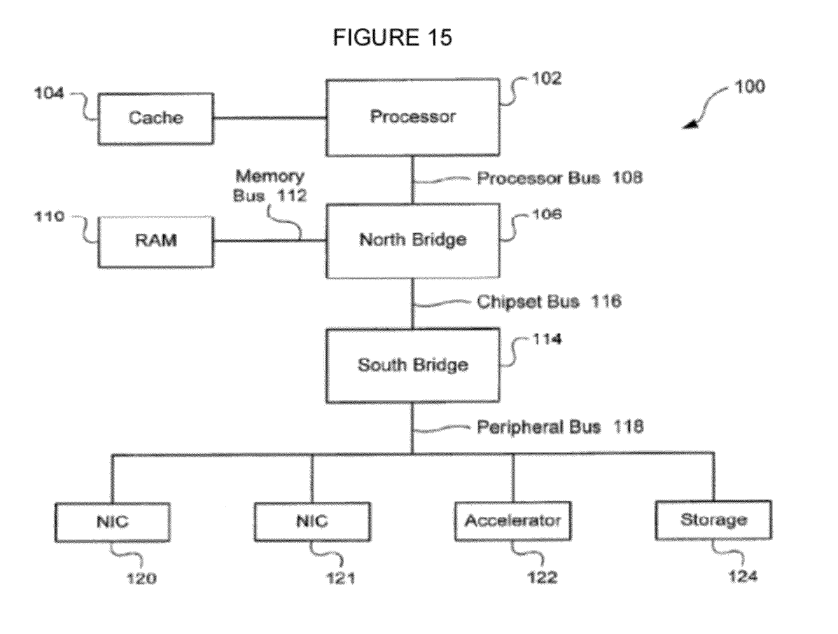

FIG. 15 is a block diagram illustrating a first example architecture of a computer system 100 that can be used in connection with example embodiments of the present invention. As depicted in FIG. 15, the example computer system can include a processor 102 for processing instructions. Non-limiting examples of processors include: Intel Xeon™ processor, AMD Opteron™ processor, Samsung 32-bit RISC ARM 1176JZ(F)-S v1.0™ processor, ARM Cortex-A8 Samsung S5PC100™ processor, ARM Cortex-A8 Apple A4™ processor, Marvell PXA 930™ processor, or a functionally-equivalent processor. Multiple threads of execution can be used for parallel processing. In some embodiments, multiple processors or processors with multiple cores can also be used, whether in a single computer system, in a cluster, or distributed across systems over a network comprising a plurality of computers, cell phones, and/or personal data assistant devices.

As illustrated in FIG. 15, a high speed cache 104 can be connected to, or incorporated in, the processor 102 to provide a high speed memory for instructions or data that have been recently, or are frequently, used by processor 102. The processor 102 is connected to a north bridge 106 by a processor bus 108. The north bridge 106 is connected to random access memory (RAM) 110 by a memory bus 112 and manages access to the RAM 110 by the processor 102. The north bridge 106 is also connected to a south bridge 114 by a chipset bus 116. The south bridge 114 is, in turn, connected to a peripheral bus 118. The peripheral bus can be, for example, PCI, PCI-X, PCI Express, or other peripheral bus. The north bridge and south bridge are often referred to as a processor chipset and manage data transfer between the processor, RAM, and peripheral components on the peripheral bus 118. In some alternative architectures, the functionality of the north bridge can be incorporated into the processor instead of using a separate north bridge chip.

In some embodiments, system 100 can include an accelerator card 122 attached to the peripheral bus 118. The accelerator can include field programmable gate arrays (FPGAs) or other hardware for accelerating certain processing. For example, an accelerator can be used for adaptive data restructuring or to evaluate algebraic expressions used in extended set processing.

Software and data are stored in external storage 124 and can be loaded into RAM 110 and/or cache 104 for use by the processor. The system 100 includes an operating system for managing system resources; non-limiting examples of operating systems include: Linux, Windows™, MACOS™, BlackBerry OS™, iOS™, and other functionally-equivalent operating systems, as well as application software running on top of the operating system for managing data storage and optimization in accordance with example embodiments of the present invention.

In this example, system 100 also includes network interface cards (NICs) 120 and 121 connected to the peripheral bus for providing network interfaces to external storage, such as Network Attached Storage (NAS) and other computer systems that can be used for distributed parallel processing.

### Example 3

### Network

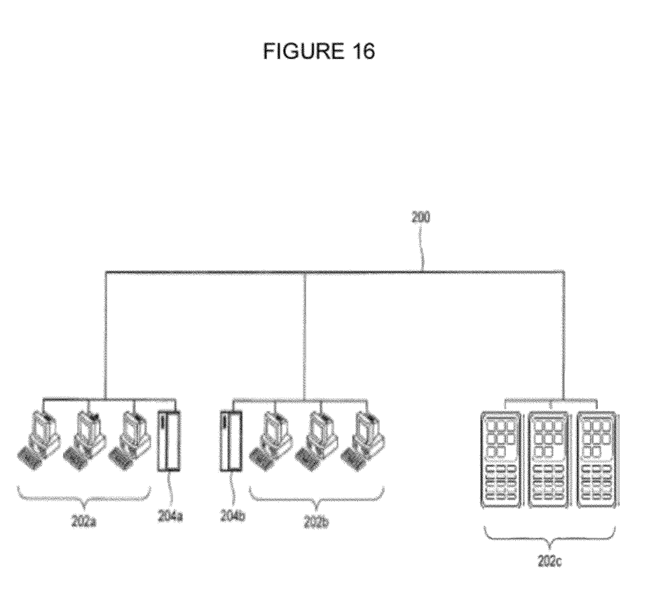

FIG. 16 is a diagram showing a network 200 with a plurality of computer systems 202a, and 202b, a plurality of cell phones and personal data assistants 202c, and Network Attached Storage (NAS) 204a, and 204b. In example embodiments, systems 202a, 202b, and 202c can manage data storage and optimize data access for data stored in Network Attached Storage (NAS) 204a and 204b. A mathematical model can be used for the data and be evaluated using distributed parallel processing across computer systems 202a, and 202b, and cell phone and personal data assistant systems 202c. Computer systems 202a, and 202b, and cell phone and personal data assistant systems 202c can also provide parallel processing for adaptive data restructuring of the data stored in Network Attached Storage (NAS) 204a and 204b. FIG. 16 illustrates an example only, and a wide variety of other computer architectures and systems can be used in conjunction with the various embodiments of the present invention. For example, a blade server can be used to provide parallel processing. Processor blades can be connected through a back plane to provide parallel processing. Storage can also be connected to the back plane or as Network Attached Storage (NAS) through a separate network interface.

In some example embodiments, processors can maintain separate memory spaces and transmit data through network interfaces, back plane or other connectors for parallel processing by other processors. In other embodiments, some or all of the processors can use a shared virtual address memory space.

### Example 4

### Multiprocessor Computer System

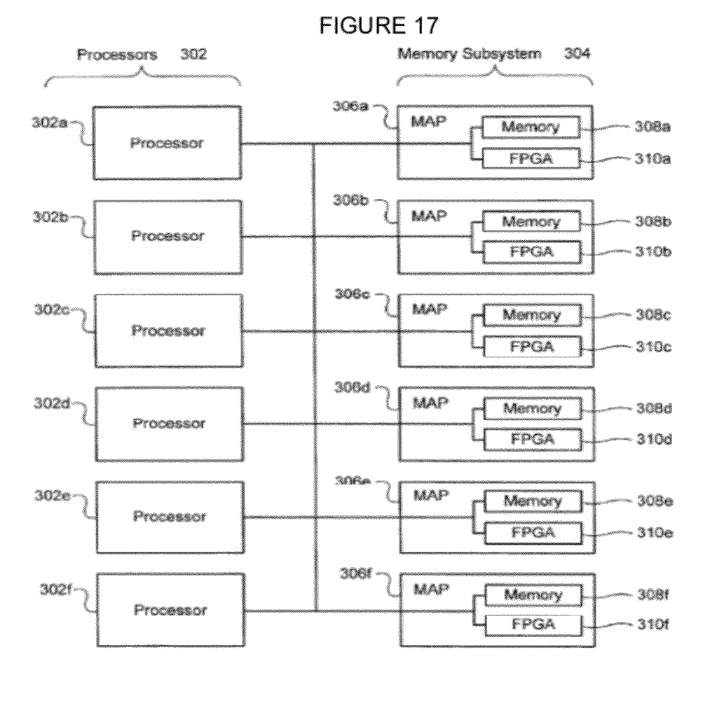

FIG. 17 is a block diagram of a multiprocessor computer system 300 using a shared virtual address memory space in accordance with an example embodiment. The system includes a plurality of processors 302a-f that can access a shared memory subsystem 304. The system incorporates a plurality of programmable hardware memory algorithm processors (MAPs) 306a-f in the memory subsystem 304. Each MAP 306a-f can comprise a memory 308a-f and one or more field programmable gate arrays (FPGAs) 310a-f. The MAP provides a configurable functional unit and particular algorithms or portions of algorithms can be provided to the FPGAs 310a-f for processing in close coordination with a respective processor. For example, the MAPs can be used to evaluate algebraic expressions regarding the data model and to perform adaptive data restructuring in example embodiments. In this example, each MAP is globally accessible by all of the processors for these purposes. In one configuration, each MAP can use Direct Memory Access (DMA) to access an associated memory 308a-f, allowing it to execute tasks independently of, and asynchronously from, the respective microprocessor 302a-f. In this configuration, a MAP can feed results directly to another MAP for pipelining and parallel execution of algorithms.

The above computer architectures and systems are examples only, and a wide variety of other computer, cell phone, and personal data assistant architectures and systems can be used in connection with example embodiments, including systems using any combination of general processors, co-processors, FPGAs and other programmable logic devices, system on chips (SOCs), application specific integrated circuits (ASICs), and other processing and logic elements. In some embodiments, all or part of the data management and optimization system can be implemented in software or hardware and that any variety of data storage media can be used in connection with example embodiments, including random access memory, hard drives, flash memory, tape drives, disk arrays, Network Attached Storage (NAS) and other local or distributed data storage devices and systems.

In example embodiments, the data management and optimization system can be implemented using software modules executing on any of the above or other computer architectures and systems. In other embodiments, the functions of the system can be implemented partially or completely in firmware, programmable logic devices such as field programmable gate arrays (FPGAs) as referenced in FIG. 17, system on chips (SOCs), application specific integrated circuits (ASICs), or other processing and logic elements. For example, the Set Processor and Optimizer can be implemented with hardware acceleration through the use of a hardware accelerator card, such as accelerator card 122 illustrated in FIG. 15.

### Embodiments

The following non-limiting embodiments provide examples of the invention, but do not define the scope of the invention.

### Embodiment 1

A personalized video education system comprising: a) a plurality of segments each comprising an educational video and a quiz, wherein each quiz contains questions associated with the educational video; b) a user-input module configured to receive personal information of a subject; c) a customized script for concatenation of two or more of the segments to generate personalized video education content based on the personal information of the subject; and d) a delivery module operable to deliver the personalized video education content to the subject, wherein the personalized video education system runs on a computer.

### Embodiment 2

The personalized video education system of embodiment 1, wherein each of the educational videos is a health education video.

### Embodiment 3

The personalized video education system of any one of embodiments 1 and 2, wherein the user-input module receives personal information of a subject from a clinician.

### Embodiment 4

The personalized video education system of any one of embodiments 1-3, wherein the user-input module receives personal information of a subject from the subject's electronic medical records (EMRs) or pharmacy medical records (PMRs).

### Embodiment 5

The personalized video education system of any one of embodiments 1-4, further comprising a reward module configured to deliver a reward to the subject based on an effort of the subject.

### Embodiment 6

The personalized video education system of embodiment 5, wherein the effort of the subject comprises viewing the personalized video education content.

### Embodiment 7

The personalized video education system of embodiment 5, wherein the effort of the subject comprises providing data to the user-input module, reading an article, answering one or more questions each based on the personalized video education content, or providing the user-input module with electronic medical records (EMRs) or pharmacy medical records (PMRs).

### Embodiment 8

The personalized video education system of any one of embodiments 5-7, wherein the reward comprises points towards completion of a certificate.

### Embodiment 9

The personalized video education system of any one of embodiments 5-8, wherein the reward comprises points redeemable for services from a redemption network, cash, health and wellness products, or discounts within a redemption network.

### Embodiment 10

The personalized video education system of any one of embodiments 5-9, wherein the reward is redeemed by email, text messages, mail, or telephone.

### Embodiment 11

The personalized video education system of any one of embodiments 1-10, wherein each of the educational videos comprises multilingual support.

### Embodiment 12

The personalized video education system of any one of embodiments 1-11, wherein each of the educational videos comprises support for the hearing impaired.

### Embodiment 13

A method for encouraging participation in an education program, the method comprising using a computer for: a) collecting one or more parameters for a subject; b) storing the collected parameters electronically; c) generating a customized educational curriculum for the subject based on the collected parameters, wherein the customized educational curriculum comprises a plurality of segments each comprising an educational video and a quiz, wherein each quiz contains questions associated with the educational video, wherein a customized script for concatenation of two or more of the segments is used to generate the customized educational curriculum based on the collected parameters; d) electronically monitoring and storing progress of the subject through the customized educational curriculum; and e) providing rewards to the subject according to progress through the customized educational curriculum.

### Embodiment 14

The method of embodiment 13, wherein each of the parameters comprises health information of the subject.

### Embodiment 15

The method of embodiment 14, wherein health information comprises electronic medical records (EMRs), pharmacy medical records (PMRs), or test results of the subject.

### Embodiment 16

The method of any one of embodiments 14-15, wherein the health information comprises information provided by the subject.

### Embodiment 17

The method of any one of embodiments 13-16, wherein the reward comprises points towards completion of a certificate.

### Embodiment 18

The method of any one of embodiments 13-17, wherein the reward comprises points redeemable for services from a redemption network, cash, health and wellness products, or discounts within a redemption network.

### Embodiment 19

The method of any one of embodiments 13-18, wherein the reward is redeemed by email, text messages, mail, or telephone.

### Embodiment 20

The method of any one of embodiments 13-19, further comprising providing a disincentive to the subject for lack of progress through the customized educational curriculum.

### Embodiment 21

The method of embodiment 20, wherein the disincentive comprises loss of rewards.

### Embodiment 22

The method of embodiment 20, wherein the disincentive comprises loss of a premier status.

### Embodiment 23

A computer system for promoting personalized health education, the system comprising: a) a user-input module operable to input personal health information of a subject; b) an educational module comprising a queue of segments, wherein at least one of the segments comprises an educational video and a quiz, wherein each quiz contains questions associated with the educational video, wherein the educational module is operable to provide personalized health education for the subject based on the subject's personal health information; c) a reminder module operable to provide a personalized reminder to the subject to: i) access personalized health educational content from the educational module; or ii) perform a health-related activity; and d) a rewards module operable to provide a reward for the subject's accessing of the personalized health educational content.

### Embodiment 24

The computer system of embodiment 23, wherein the reminder module sends a reminder to the subject on a time frame desired, specified, or requested by the subject

### Embodiment 25

The computer system of any one of embodiments 23-24, wherein each of the segments comprises at least one educational video and a quiz, wherein each quiz contains questions associated with the educational video.

### Embodiment 26

The computer system of any one of embodiments 23-25, wherein the reminder module is triggered as a result of clinician input.

### Embodiment 27

The computer system of any one of embodiments 23-25, wherein the reminder module is triggered as a result of input by the subject.

### Embodiment 28

The computer system of any one of embodiments 23-27, wherein the personalized reminder is delivered by email, text messages, mail, or telephone.

### Embodiment 29

The computer system of any one of embodiments 23-28, wherein the reward comprises points towards completion of a certificate.

### Embodiment 30

The computer system of any one of embodiments 23-29, wherein the reward comprises points redeemable for services from a redemption network, cash, health and wellness products, or discounts within a redemption network.

### Embodiment 31

The computer system of any one of embodiments 23-30, wherein the reward is redeemed by email, text messages, mail, or telephone.

### Embodiment 32

A method for promoting personalized health education, the method comprising using a computer for: a) analyzing health information of a subject; b) providing personalized health education for the subject based on the subject's health information, wherein the personalized health education comprises at least one educational video and a quiz, wherein each quiz contains questions associated with the educational video; c) providing a personalized reminder to the subject to: i) access personalized health educational content from the educational module; or ii) perform a health-related activity; and d) providing a credit for the subject's accessing of the personalized health educational content, wherein the credit can be redeemed for a reward.

### Embodiment 33

The method of embodiment 32, wherein the personalized reminder is triggered by the subject.

### Embodiment 34

The method of embodiment 32, wherein the personalized reminder is triggered by a clinician.

### Embodiment 35

The method of any one of embodiments 32-34, wherein the personalized reminder is delivered by email, text messages, mail, or telephone.

### Embodiment 36

The method of any one of embodiments 32-35, wherein the reward comprises points towards completion of a certificate.

### Embodiment 37

The method of any one of embodiments 32-36, wherein the reward comprises points redeemable for services from a redemption network, cash, health and wellness products, or discounts within a redemption network.

### Embodiment 38

The method of any one of embodiments 32-37, wherein the reward is redeemed by email, text messages, mail, or telephone.

### Embodiment 39

The method of any one of embodiments 32-38, wherein the accessing of the personalized health educational content comprises reading an article, taking a quiz, or watching a video.

### Embodiment 40

The method of any one of embodiments 32-39, wherein the health information of the subject is derived from electronic medical records (EMRs), pharmacy medical records (PMRs), or clinician input.

### Embodiment 41

The method of any one of embodiments 32-40, wherein the personalized health educational content comprises information about a disease.

### Embodiment 42

The method of any one of embodiments 32-41, wherein the personalized health educational content comprises information about a medical test.

### Embodiment 43

The method of any one of embodiments 32-42, wherein the reward is personalized based on the health information of the subject.

### Embodiment 44

The method of any one of embodiments 32-43, wherein the credit is provided based on the frequency of the subject's accessing of the personalized health educational content.

### Embodiment 45

The method of any one of embodiments 32-44, further comprising providing information to a clinician about the credits awarded to the subject.

What is claimed is:

1. A personalized video education system comprising:
a) a plurality of segments each comprising an educational video and a quiz, wherein each quiz contains questions associated with the educational video;
b) a user-input module configured to receive personal information of a subject;
c) a customized script for concatenation of two or more of the segments to generate personalized video education content based on the personal information of the subject; and
d) a delivery module operable to deliver the personalized video education content to the subject,
wherein the personalized video education system runs on a computer.

2. The personalized video education system of claim 1, wherein each of the educational videos is a health education video.

3. The personalized video education system of claim 1, wherein the user-input module receives personal information of a subject from a clinician.

4. The personalized video education system of claim 1, wherein the user-input module receives personal information of a subject from the subject's electronic medical records (EMRs) or pharmacy medical records (PMRs).

5. The personalized video education system of claim 1, further comprising a reward module configured to deliver a reward to the subject based on an effort of the subject.

6. The personalized video education system of claim 5, wherein the effort of the subject comprises viewing the personalized video education content.

7. The personalized video education system of claim 5, wherein the effort of the subject comprises providing data to the user-input module, reading an article, answering one or more questions each based on the personalized video education content, or providing the user-input module with electronic medical records (EMRs) or pharmacy medical records (PMRs).

8. The personalized video education system of claim 5, wherein the reward comprises points towards completion of a certificate.

9. The personalized video education system of claim 5, wherein the reward comprises points redeemable for services from a redemption network, cash, health and wellness products, or discounts within a redemption network.

10. The personalized video education system of claim 5, wherein the reward is redeemed by email, text messages, mail, or telephone.

11. The personalized video education system of claim 1, wherein each of the educational videos comprises multilingual support.

12. The personalized video education system of claim 1, wherein each of the educational videos comprises support for the hearing impaired.

13. A method for encouraging participation in an education program, the method comprising using a computer for:
a) collecting one or more parameters for a subject;
b) storing the collected parameters electronically;
c) generating a customized educational curriculum for the subject based on the collected parameters, wherein the customized educational curriculum comprises a plurality of segments each comprising an educational video and a quiz, wherein each quiz contains questions associated with the educational video, wherein a customized script for concatenation of two or more of the segments is used to generate the customized educational curriculum based on the collected parameters;
d) electronically monitoring and storing progress of the subject through the customized educational curriculum; and
e) providing rewards to the subject according to progress through the customized educational curriculum.

14. The method of claim 13, wherein each of the parameters comprises health information of the subject.

15. The method of claim 14, wherein health information comprises electronic medical records (EMRs), pharmacy medical records (PMRs), or test results of the subject.

16. The method of claim 14, wherein the health information comprises information provided by the subject.

17. The method of claim 13, wherein the reward comprises points towards completion of a certificate.

18. The method of claim 13, wherein the reward comprises points redeemable for services from a redemption network, cash, health and wellness products, or discounts within a redemption network.

19. The method of claim 13, wherein the reward is redeemed by email, text messages, mail, or telephone.

20. The method of claim 13, further comprising providing a disincentive to the subject for lack of progress through the customized educational curriculum.

21. The method of claim 20, wherein the disincentive comprises loss of rewards.

22. The method of claim 20, wherein the disincentive comprises loss of a premier status.

23. A computer system for promoting personalized health education, the system comprising:
a) a user-input module operable to input personal health information of a subject;
b) an educational module comprising a queue of segments, wherein at least one of the segments comprises an educational video and a quiz, wherein each quiz contains questions associated with the educational video, wherein the educational module is operable to provide personalized health education for the subject based on the subject's personal health information;
c) a reminder module operable to provide a personalized reminder to the subject to:
i) access personalized health educational content from the educational module; or
ii) perform a health-related activity; and
d) a rewards module operable to provide a reward for the subject's accessing of the personalized health educational content.

24. The computer system of claim 23, wherein the reminder module sends a reminder to the subject on a time frame desired, specified, or requested by the subject.

25. The computer system of claim 23, wherein each of the segments comprises at least one educational video and a quiz, wherein each quiz contains questions associated with the educational video.

26. The computer system of claim 23, wherein the reminder module is triggered as a result of clinician input.

27. The computer system of claim 23, wherein the reminder module is triggered as a result of input by the subject.

28. The computer system of claim 23, wherein the personalized reminder is delivered by email, text messages, mail, or telephone.

29. The computer system of claim 23, wherein the reward comprises points towards completion of a certificate.

30. The computer system of claim 23, wherein the reward comprises points redeemable for services from a redemption network, cash, health and wellness products, or discounts within a redemption network.

31. The computer system of claim 23, wherein the reward is redeemed by email, text messages, mail, or telephone.

32. A method for promoting personalized health education, the method comprising using a computer for:
a) analyzing health information of a subject;
b) providing personalized health education for the subject based on the subject's health information, wherein the personalized health education comprises at least one educational video and a quiz, wherein each quiz contains questions associated with the educational video;
c) providing a personalized reminder to the subject to:
i) access personalized health educational content from the educational module; or
ii) perform a health-related activity; and
d) providing a credit for the subject's accessing of the personalized health educational content, wherein the credit can be redeemed for a reward.

33. The method of claim 32, wherein the personalized reminder is triggered by the subject.

34. The method of claim 32, wherein the personalized reminder is triggered by a clinician.

35. The method of claim 32, wherein the personalized reminder is delivered by email, text messages, mail, or telephone.

36. The method of claim 32, wherein the reward comprises points towards completion of a certificate.

37. The method of claim 32, wherein the reward comprises points redeemable for services from a redemption network, cash, health and wellness products, or discounts within a redemption network.

38. The method of claim 32, wherein the reward is redeemed by email, text messages, mail, or telephone.

39. The method of claim 32, wherein the accessing of the personalized health educational content comprises reading an article, taking a quiz, or watching a video.

40. The method of claim 32, wherein the health information of the subject is derived from electronic medical records (EMRs), pharmacy medical records (PMRs), or clinician input.

41. The method of claim 32, wherein the personalized health educational content comprises information about a disease.

42. The method of claim 32, wherein the personalized health educational content comprises information about a medical test.

43. The method of claim 32, wherein the reward is personalized based on the health information of the subject.

44. The method of claim 32, wherein the credit is provided based on the frequency of the subject's accessing of the personalized health educational content.

45. The method of claim 32, further comprising providing information to a clinician about the credits awarded to the subject.
